(19) United States
(12) Patent Application Publication
(10) Pub. No.: US 2006/0031235 A1
(43) Pub. Date: Feb. 9, 2006

(54) Expression and time-based data creation and creator-controlled organizations

(75) Inventors: Stefano Foresti, Salt Lake City, UT (US); Bijan M. Marashi, San Francisco, CA (US); Shane Adams, Alameda, CA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Xoopit, Inc., Salt Lake City, UT (US)

(21) Appl. No.: 11/100,633

(22) Filed: Apr. 7, 2005

Related U.S. Application Data
(60) Provisional application No. 60/559,980, filed on Apr. 7, 2004.

(51) Int. Cl. G06F 7/00

(52) U.S. Cl. 707/100

(57) ABSTRACT

A system and method of electronically managing expression comprises receiving an expression object, the expression object comprising a data expression being determined by a creator and based on a creator-defined structure, the data expression and the structure being definable by the creator independent of any predefined structure of a software application and transmitting the expression object for storage at a data storage system. The expression object may be stored in a data storage system using a permanent expression object identifier associated with the creator to enable the creator to have permanent access to the expression object using the permanent expression object identifier. The creator or others may define one or more relationships relative to at least a first portion of a data expression object and a second portion of a data expression.

### RELATED APPLICATION

This application claims priority to U.S. Provisional Application No. 60/559,980 entitled “Improved Information Technology Systems and Methods,” the entirety of which is hereby incorporated by reference.

### FIELD OF THE INVENTION

The present inventions relate to systems and method for data creation and storage using expression and time along with creator control over subsequent organization of the data.

### BACKGROUND OF THE INVENTION

The history of electronic information technology (from now on indicated as “IT”) shows that it has evolved to produce progressively more functionality, faster processing and complex user interfaces. However, the implementation of technology in society has grown progressively farther apart from the natural human way of thinking and communicating information, as compared to the functionality of our brain and the evolution of information and communication technology for millennia. Unfortunately, today's IT is both complex and complicated. Complexity is about multiple successive hierarchical levels in its structure and processes. Complication is the unnecessary insertion of useless components for the task

Today, humans in the society of pervasive information technology have a problem knowing how to keep, organize and find their personal information with all the computing, recording, and communication technology that the person has available to him or her. It is very hard to quantify the impact of this problem on individual's well being, business processes and the society as a whole. People generally complain about information technology. An example illustrates the point. Suppose you have an expression that says:

“Let's have dinner with John, next Wednesday at 8 pm: call him at 987-6543; before coming, buy a bottle of wine and a baguette.”

A user typically would have difficulty knowing where to store this message. The user could place it in the “to do” portion of a program, in the calendar, in the contacts, or in a word processing file, but by choosing one of those places, it would necessarily exclude another that would make the information more useful. It is just some simple text that belongs to multiple places, and unless you replicate it in multiple places the single parts will not be found.

Most people patch the endemic problem with many workarounds such as by re-inputting contacts in contact managers in cell phones, PC, at any purchase, by writing notes on paper and rewriting on the computer and by sending emails to themselves as a reminder.

Most of the daily information management is text. Despite the power of information technology (both software and hardware) people do not have a way to simply collect and organize their information in a way that it can be easily found and reused. Every person is confronted with the decision of whether to record information on a piece of paper or in one of the information technology devices.

Electronically stored information can not be found because it is disaggregated. Information is spread around and replicated among multiple hardware devices and files in software applications using a proprietary (often closed) format. Information is disorganized in that each application imposes an organization of human expression, “files” are the information atom, while concepts may be smaller units, file names, directories, and timestamps randomize the identification of information and user interfaces confuse the user expression with the view of existing information. Information gets erased (permanently) because people are required to “save” files, but may forget, or not do it enough, failure of hardware, software, power, etc., mistakes and misunderstanding in naming and identification, “undo” has limited depth, if available at all, backups are non trivial and time consuming. Information becomes Inaccessible in that despite the person's right or intent, information may not be available at a certain time, to a certain person, or in a certain place or device. Information does not always get recorded. Often users would like to record and structure information in electronic media, but it may take too long to learn how to do it, the effort to get started overcomes the spontaneity or window of opportunity, it may take multiple repetitive tasks to enter the same data into forms, applications, etc., there may not exist a software application for the desired task, and the confidentiality of information technology is not trusted. Information is often excessive. Excess is not a problem if the information is useful, but is a multiplier of the problem if information is disorganized, disaggregated, replicated, unidentified, etc.

Information is hard to find mainly because it is trapped in applications and devices. Searching is often unsuccessful, not only across devices, but even inside applications (e.g. Microsoft Outlook).

On the commercial side, technology companies make money with upgrades, which are forced upon users with file compatibility tricks. Companies also try to scrape more functionality from other devices or apps. Whether or not the upgrades improve the user needs, the strategy maximizes their profit. Therefore, improvements are very incremental, with piecemeal synchronization of devices, while the person's data is hijacked in the constant battles between competitors and standardization of file formats. Current business models work best with these incremental increases rather than addressing the core problem with major changes.

On the research side, computer science has been focused on many efforts that point to the ideal to give life to computers by learning humans and automate their tasks. Less attention has been given to support the way humans think, want and express, and to let humans be understood by computers.

On the individual side, people are all astounded by the great and powerful things computers do: thus they tend to believe that information technology must be this way, and accept it even when it is more trouble than help. People fundamentally rely on paper for important things and voice for confidential matters.

The value of information technology was initially hardware, then software since the PC era. This focuses was on the technology, not on the information. It is hard to place value to information if there is not a rigorous model that supports it.

The current information and communication technology does not allow humans to express and structure information the way they do in their mind. The IT industry over the last five decades has effectively created a way of managing and communicating information that often runs on a separate track of human life and communications. Any technologically powered individual can examine his or her own day to day activities to realize that many tasks started on a computer need to be finished off-line with a phone call, a personal meeting, or a piece of paper. One of the main reasons is that computer applications provide a set of predefined features and data fields for the user to select and input that are not necessarily what the user thinks to do.

Today's computers allow humans to perform a lot of processing that their brain can not do (at least within a length of time that makes the value of the computation worthwhile). However, it is not as easy to let computers have access to all information a human has, has access to, and wants.

Vice versa, humans know how to process a lot of information, but can't keep all details in their brain. Therefore, information technology shall be the extended brain. In order to do that, IT shall be governed by equivalent rules that apply to the information in the brain. Unfortunately, IT is not governed by the natural social rules and laws that have been developed for the information in one's brain and the interpersonal communications.

In existing IT systems, the user is severely limited from naturally expressing and recording thoughts or various forms of personal expression. Computer applications typically provide a set of predefined features and data fields for the user to select and input, that are not necessarily what the user thinks to do. As a result, most people often put aside PDAs and laptops and use paper notebooks, sticky notes, boards, voice recorders, with which they can freely express whatever they feel. Later, they may try to import into an application format part of the information they input on paper.

These and other drawbacks exist with current systems and methods.

### SUMMARY OF THE INVENTION

Accordingly, various embodiments of the present inventions may be directed to a system and method of electronically managing expression. An expression object may be received that comprises a data expression that is determined by a creator and based on a creator-defined structure. The data expression and the structure may be definable by the creator independent of any predefined structure of a software application. The expression object may then be transmitted for storage at a data storage system. The expression object may comprise a portion of a file and may have a structure that is not dictated by any application in which data expression occurs. The expression object may be a subset of a structure dictated by an application in which data expression occurs. The expression object may further have a time identifier indicating a time between the beginning and the end time of said expression. The data expression may then be defined as an expression between a beginning and an end time that is determined by the creator. A creator identifier may be associated with the expression object as may an electronic address identifier, such as a permanent address identifier for use throughout a networked system.

Relationships may be defined relative to expression objects, such as categories, tags, links or others that may apply to the entire data expression or portions thereof. The data expression may be captured in a variety of ways, including capturing activity on a device in chronological order and using the chronological ordered capture to capture expression into an expression object. Multiple expressions may be created at the same time and expression objects may be incorporated into other expression objects. Expression objects may be created at one device and immediately relayed and uploaded to other devices associated with the creator. The expression may be captured through a default user interface without having to open a specific application prior to expression.

As a result, the method and system enable a creator free input expression with the ability to store the information permanently in a data storage system associated with the creator. The creator may then access the data from any authorized device (e.g., PC, laptop, PDA, cell phone, pager device, web servers).

The received expression may be received as part of a continuous chronological capturing of expressions from the creator wherein the receipt of an expression object is initiated by an input from the creator, such as selection of an icon on a user interface the creator is using.

Further, the upon receipt at the data storage system, the expression object may be automatically shared with one or more other devices associated with the creator such that, if desired, all devices associated with the creator may be automatically provided with expression objects created, regardless of the device on which they were created by the creator. So, for example, if a user creates and expression object on his or her cellphone, that expression object is stored at the databank and then automatically shared on the creator's laptop computer as well.

Various embodiments of the present inventions may also be directed to a system and method for receiving an expression object associated with a creator, the expression object comprising a creator-defined data expression and storing the expression object in a data storage system using a permanent expression object identifier associated with the creator to enable the creator to have permanent access to the expression object using the permanent expression object identifier. The expression object may be permanently available to the creator from any device enabled for communication with the data storage system. A single input may be used to indicate an intention by the creator to permanently store one or more portions of the data expression. Input may be received from a device authorized by the creator to download all or a portion of all expression objects associated with the creator and in such a case, all selected expression objects associated with the creator may be transmitted to the authorized device. In so transmitting, the system may also transmit associated relationships between expression objects. In this way, the creator shares expression objects with another person by providing authorization to a device associated with the other person to access the expression objects associated with the creator. Thus, in one embodiment, upon receiving a destination device for a person other than the creator, the destination device being approved by the creator to access the expression objects and receiving a single input to transmit all selected matching expression objects associated with the creator to the destination device, the system may transmit all selected matching expression objects associated with the creator to the destination device, along with the creator-defined tags and the creator-defined organizational tagging.

Various embodiments of the present inventions may also be directed to a system and method for organizing data expression that involves receiving an expression object, the expression object comprising a data expression defined by the creator and receiving input from the creator to define one or more relationships relative to at least a first portion of a data expression object and a second portion of a data expression. The first and second portions may be from a single data expression and the relationships may be defined using categories for one or more portions of the data expression, tags associated with one or more portions of the data expression and/or links between one or more data expressions. The relationship may be a creator-defined structure with creator-defined categories, tags and/or links.

Other advantages and embodiments of the present invention may be appreciated from the descriptions and figures herein.

### BRIEF DESCRIPTION OF THE DRAWINGS

FIG. 1 depicts an overview system diagram according to an embodiment of the present invention.

FIG. 2 depicts an system diagram illustrating device networking according to an embodiment of the present invention.

FIG. 3 depicts an embodiment of a user device according to an embodiment of the present invention.

FIG. 4 depicts an embodiment of a centralized storage databank system according to an embodiment of the present invention.

FIG. 5 depicts an illustrative schematic depicting an expression and relationships for portions of the expression according to an embodiment of the present invention.

FIG. 6 depicts an illustrative schematic depicting relationships between relationship objects and an expression object.

FIG. 7 depicts an illustrative schematic depicting a method of transferring expressions from disparate devices for availability to a creator at a single device according to an embodiment of the present invention.

FIG. 8 depicts an illustrative schematic depicting illustrative forms of expression and related expression objects according to an embodiment of the present invention.

FIG. 8(b) depicts an example decomposition of a data expression according to an embodiment of the present invention.

FIG. 9 depicts an illustrative schematic depicting graphical relationships between a creator and expression objects according to an embodiment of the present invention.

FIG. 10 depicts an illustrative schematic depicting capturing of a plurality of expression objects during an overlapping time period according to an embodiment of the present invention.

FIG. 11 depicts an illustrative schematic depicting relationships between expression objects according to an embodiment of the present invention.

FIG. 12 depicts an illustrative schematic depicting search on an expression object retrieving related expression objects according to an embodiment of the present invention.

FIG. 12(b) depicts an illustrative schematic of storage of information according to an embodiment of the present invention.

FIG. 13 depicts a schematic comparison between prior art information technology systems and illustrative embodiments of the present invention.

FIG. 14 depicts a schematic overview of various aspects of illustrative embodiments of the present invention.

FIG. 15 depicts an illustrative user interface for use with various embodiments of the present invention.

FIG. 16 depicts an illustrative user interface depicting a listing of expression objects available to a user according to an embodiment of the present invention.

FIG. 17 depicts an illustrative interface depicting tags developed by a creator for organizing expression objects according to an embodiment of the present invention.

FIG. 18 depicts an illustrative interface depicting results of a search of expression objects according to an embodiment of the present invention.

FIG. 19 depicts a listing of expression objects by time according to an embodiment of the present invention.

FIG. 20 depicts results of a search of expression objects according to another embodiment of the present invention.

FIG. 21 depicts a schematic understanding of information flow according to an embodiment of the present invention.

FIG. 22 depicts a schematic representation of information flow according to an embodiment of the present invention.

FIG. 23 depicts a schematic representation of the relationship between embodiments of the present invention and a person.

FIG. 24 depicts a schematic view of the flow of information between users and the exemplary systems of the present invention.

FIG. 25 depicts an object view of an expression according to an embodiment of the present invention.

FIG. 26 depicts a genealogic view of an expression object according to an embodiment of the present invention.

FIG. 27 depicts a network view of expression objects according to an embodiment of the present invention.

FIG. 28 depicts a chronological view of expression objects according to an embodiment of the present invention.

FIG. 29 depicts a creator's view of expression objects according to an embodiment of the present invention.

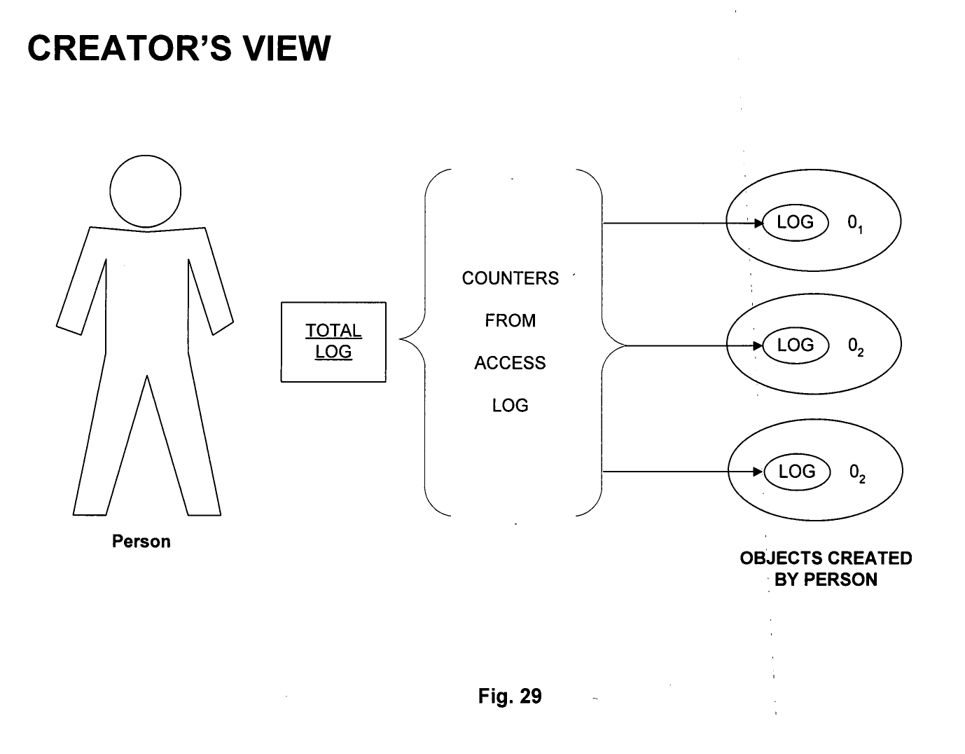

FIG. 30 depicts a schematic representation of a relationship between free expression and input according to an embodiment of the present invention.

FIG. 31 depicts an exemplary free expression input according to an embodiment of the present invention.

FIG. 32 depicts a schematic representation of relationships between data expression and expression objects according to an embodiment of the present invention.

FIG. 33 depicts a chronological memory of expression objects according to an embodiment of the present invention.

FIG. 34 depicts a schematic representation of decomposing objects into new expression objects according to an embodiment of the present invention.

FIG. 35 depicts an example decomposition of a data expression into expression objects according to an embodiment of the present invention.

FIG. 36 depicts an example of structuring expression objects according to an embodiment of the present invention.

FIG. 37 depicts an example of providing input, structure and storage of personal expression according to an embodiment of the present invention.

FIG. 38 depicts another example of structuring an expression object according to an embodiment of the present invention.

FIG. 39 depicts an exemplary method of expressing, relating and storing expression objects according to an embodiment of the present invention.

FIG. 40 depicts an example of expression of relationships between objects in personal storage and objects elsewhere according to an embodiment of the present invention.

FIG. 41 depicts an exemplary schematic for assigning permanent addresses according to an embodiment of the present invention.

FIG. 42 depicts an example of storage segmentation according to an embodiment of the present invention.

FIG. 43 depicts an example of storage segmentation according to another embodiment of the present invention.

FIG. 44 depicts an example of expression object copying for preservation according to an embodiment of the present invention.

FIG. 45 depicts an exemplary user interface for expression according to an embodiment of the present invention.

### DETAILED DESCRIPTION OF EXEMPLARY EMBODIMENTS

According to an embodiment of the present invention, a system and method are provided for enabling creator-defined and structure storage of information. In this patent application, the terminology “extended brain” may be used to explain embodiments described herein. In no way should this term be limited to specific examples or embodiments described. Rather, one of ordinary skill in the art should appreciate that the terminology is being used to the reader to gain a better understanding of how the advantages that some of the various embodiments of the present inventions achieve.

According to the present invention, various embodiments are provided that meet the need to make humans organize the information they produce and consume, rather than expecting that the structure in the data is found by better searching and machine learning algorithms. Solutions to this problem may be met by focusing on two interconnected goals: supporting humans to express and organize information, and permanent electronic memory for life, either of which provide a major innovation over the art.

These goals may be met through use of a data model that maps naturally onto the way humans express, think and memorize information: concepts and relationships among them. Several factors that may comprise part of the data model include authorship, time of expression, identification and access control. As for authorship, currently files are the cumulative contribution of one or many people. However, it is not possible to discern who did what: the file author, if encoded, may not correspond to the content author, but to the last system username of the application used. As for time of expression, the timestamp of files in existing systems may be changed regardless of whether the file has actually being modified or not. The chronology of information production is equivocal. As for identification, file names in existing systems are a burden when people are forced to think of one, and then hide the information contained in it. It happens to most PC users to have many versions of a file that contain multiple changes, and it's not clear which was what. As for access control, access to information is at the system and application level: the result is the vulnerable and unstructured security that we all know and experience. Access control may be one of the parameters of information itself in the embodiments of the present invention.

A digital canvas method of organization according to one embodiment of the present invention may be based on one or more of the following principles: humans determine what constitutes an expression, humans express operations on data, instead of selecting from application menus, humans may express any relationship among any information they want, expression is automatically memorized without a “save” button, expression is encoded with a permanent identifier, and/or expression is permanently recorded (i.e. can not be erased)

Various embodiments of the present invention illustrate a method and system for rearranging the several powerful components of information technology to map onto the natural way of thinking and communicating of humans, and specifically in support of the way human brain works and matching the principles of information and communication developed by humanity.

Various embodiments described herein provide an improved information technology model that represents a significant improvement over traditional paper and telephone based information technology with little drawback. One or more of these embodiments enable (1) recording any desired information, (2) determining what constitutes an information object(s), (3) associating information in relationships, (4) making wanted information available anytime, anywhere, to anyone allowed, (5) viewing much information and associate it in different ways, (6) manipulating any information to produce new information, and (7) avoiding reproducing information.

These embodiments increase the possibility for associating useful information while decreasing the time and mental effort to do it. One or more of the embodiments described herein apply the guidelines (law, social values and “common sense”) to IT that humanity has been developing in the real world. The value of electronic IT is that it can apply such rules in a microstructure of the information economy and to a scalable number of people worldwide.

IT is currently focused on applications and process flow. In this environment data suddenly interrupts its cyberspace flow into replicated paper copies. One or more embodiments of the present invention(s) create the foundation to allow data to flow through all processes and seamlessly both digitally in IT and through the brain.

Accordingly, various embodiments of the present improved information technology model may enable one or more of the following principles: express information, record expressions, express relationships among information, search information and relationships, view desired information in desired ways, visualize associations of information in several ways, define ownership inherently by its expression, assign access rights, reuse information, and reward creativity and production.

In various embodiments of the present invention, IT becomes an extension of the human brain through a model that supports data flowing from and to people. The following components may be implemented to enable IT to operate as the extension of the brain.

Overview and System Architecture

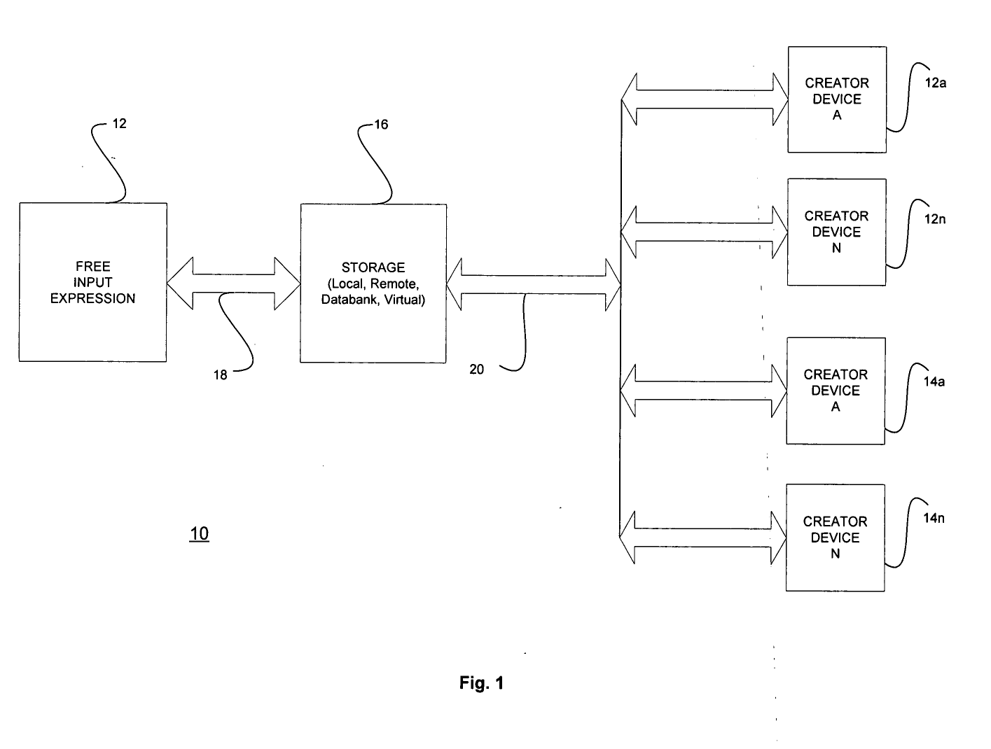

FIG. 1 depicts an overview of a system. A user inputs a free expression in device 12, the expression being composed of multiple expression objects that are stored on a databank 16 via a network connection 18, the databank 16 being either local or remote, and either central or distributed. The expressions can later be accessed by the creator or another recipient, using any device 12a-n, 14a-n, via a network connection 20. As described through, network connections 18 and 20 may be any kind of network, including different physical connections (landline, wireless, etc.) and transmission protocols (telephone, cable, Internet, IP telephony, wireless, etc.). Moreover, databank 16 may comprise virtual storage (storage at a plurality of locations accessible on a network).

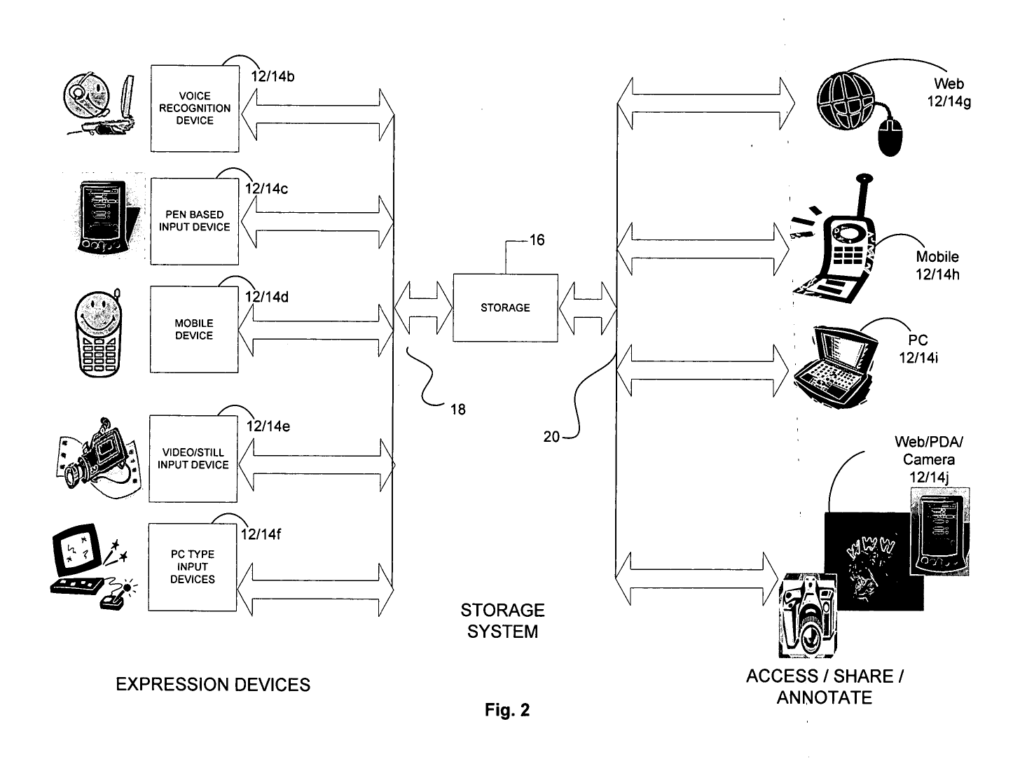

FIG. 2 describes that the free input may performed in any expression device, including voice recorder 12/14b, pen 12/14/c, a mobile phone 12/14d, a video or image capture device 12/14e, or on a keyboard 12/14f. The expression can be searched, accessed, shared, and annotated on a variety of devices or network enabled applications, including a web browser 12/14g, a mobile phone 12/14h, a PC client 12/14i, or a Web/PDA/camera 12/14j.

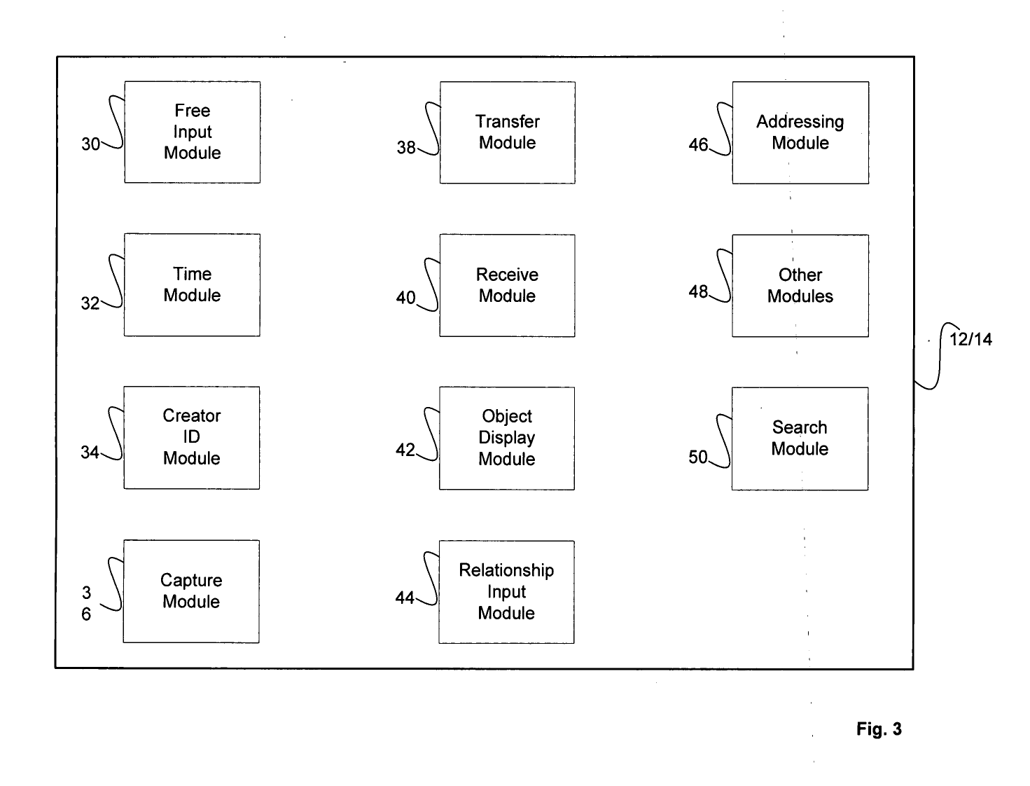

FIG. 3 depicts an embodiment of modules that may be incorporated or accessible to a creator/receiver device 12/14. Such modules may include one or more of the following: a free input module 30, a time module 32, a creator ID module 34, a capture module 36, a transfer module 38, a receive module 40, an object display module 42, a relationship input module 44, an addressing module 46, a search module 50 and/or one or more other modules 48.

Free input module 30 may present an interface through which a creator may provide free input as described in greater detail below. Free input module 30 may receive the input and process it for use in creation of expression objects.

Time module 32 may provide functionality for tracking time relative to expressions, including starting time of an expression, ending time of an expression and other unique time-based data for association with an expression. Time module 32 may generate a time identifier for use in an expression object as described herein.

Creator ID module 34 may provide functionality for identifying, requesting, retrieving or otherwise deriving an identification for the creator and providing that creator identification to other modules. For example, creator ID module 34 may be used to provide a creator ID for storage in association with an expression object.

Capture module 36 may provide functionality for capturing expression, whether written, types, spoken, sensed, viewed, or otherwise. Existing capturing techniques may be used to perform this functionality.

Transfer module 38 may provide functionality to transfer expression and expression objects from device 12/14 to storage system 16 or other systems. This functionality may include an automatic transfer upon capture of an expression object for permanent storage according to an embodiment described below. Existing data transfer methodologies, techniques and systems may be employed according to various embodiments of the present invention.

Receive module 40 may provide functionality to receive expression objects and other data from storage system 16 and other systems. Object display module 42 may provide functionality to display expressions and expression objects.

Relationship input module 44 may provide functionality to enable a user to provide input for relationships between portions of data expression and/or expression objects as described in greater detail below. Relationships that may be received include categorizations, tags and links, among others.

Addressing module 46 may provide functionality to provide addresses, such as permanent addresses in some embodiments, for expression objects. Addressing module 46 may cooperate with storage system 16 to assign unique addresses as described in greater detail below.

Search module 50 may provide functionality for searching on expression objects and portions thereof, including the relationships associated with expression objects. Known and existing search technologies may be employed. Other modules 48 may also be provided as desired.

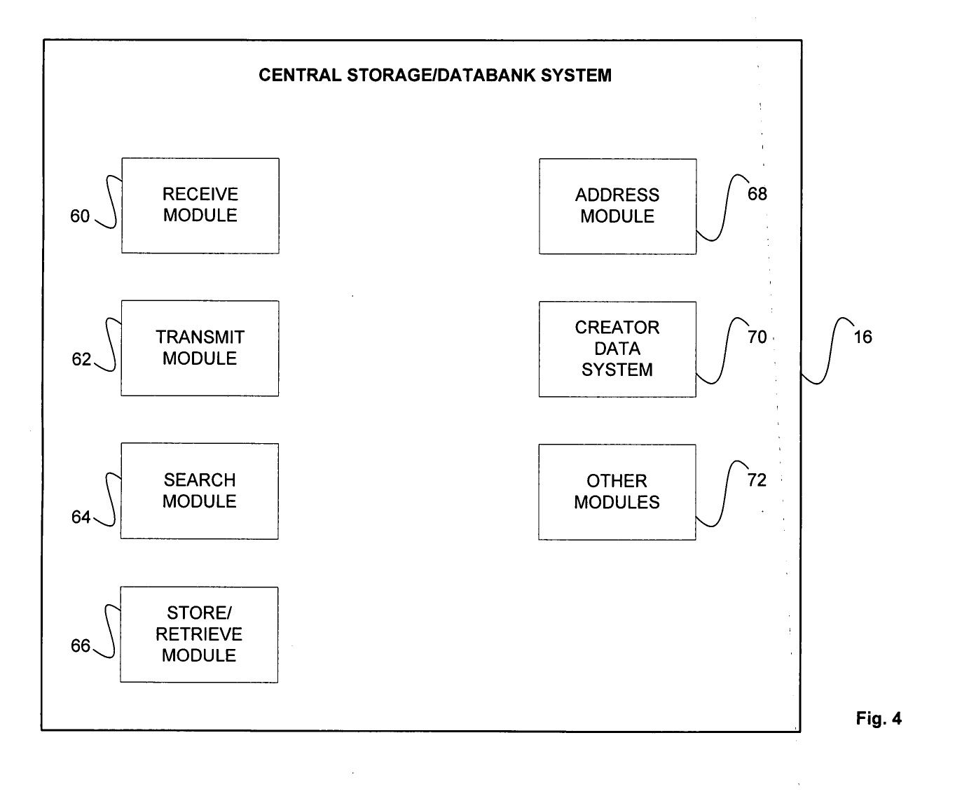

FIG. 4 depicts an example of various modules that may be provided in associated with a central storage/database system. Since the storage system 16 may comprise a virtual storage system with storage at multiple locations, the functionality of these modules may reside at each storage location, at a central location or distributed among various locations.

Storage system 16 may comprise a receive module 60 may provide functionality to receive expression objects and other data from creator and receive systems 12/14. Transmit module 62 may provide functionality for transmitting expression objects and associated relationships.

Search module 66 may provide functionality for searching on expression objects and portions thereof, including the relationships associated with expression objects. Known and existing search technologies may be employed.

Addressing module 68 may provide functionality to provide addresses, such as permanent addresses in some embodiments, for expression objects. Addressing module 46 may cooperate with creator systems 12 and receiver systems 14 to assign unique addresses as described in greater detail below.

Creator data system 70 may provide functionality for keeping track of creators participating in the system. Other modules 72 may also be provided. Further, system 16 may incorporate data storage systems as are well known in the art.

It should be appreciated that some or all of these modules may be merged, eliminated or moved to a different system as desired without departing from the scope of the present invention.

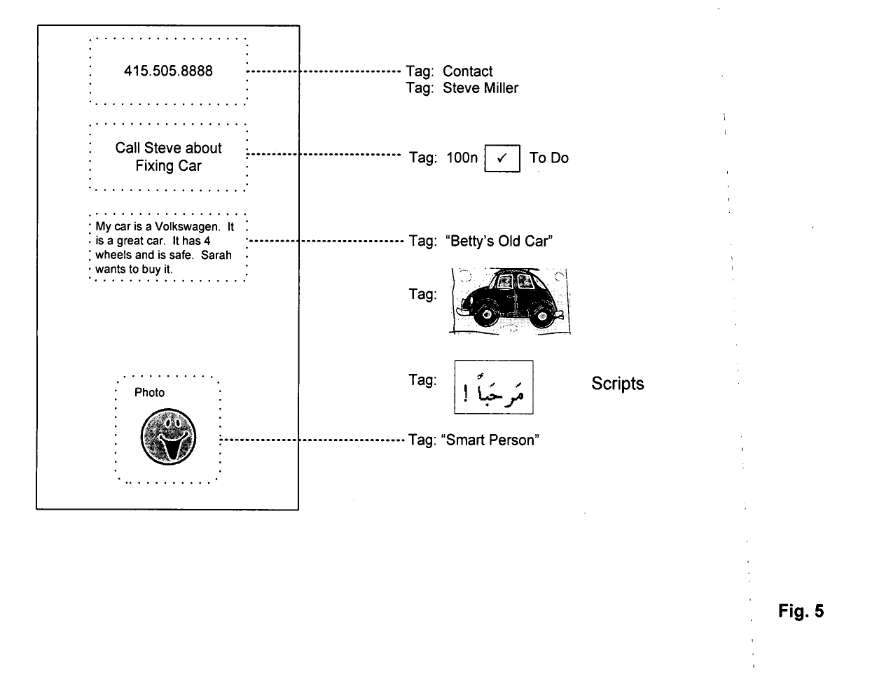

FIG. 5 depicts how it is possible to select parts of an expression, and to assign each of them to different user-defined tags.

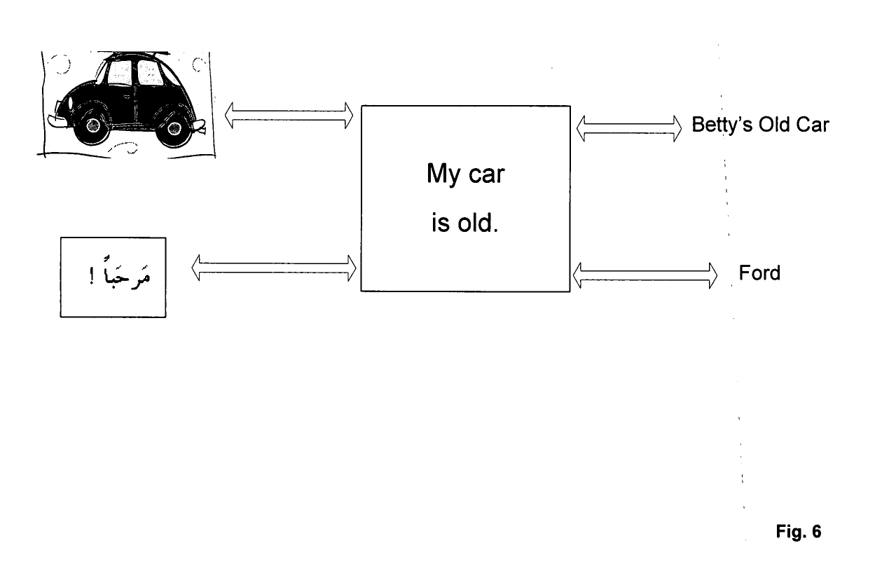

FIG. 6 depicts an example of a single expression being tagged with a plurality of tags, each of a different type, including a photo, a script, an expression and a word.

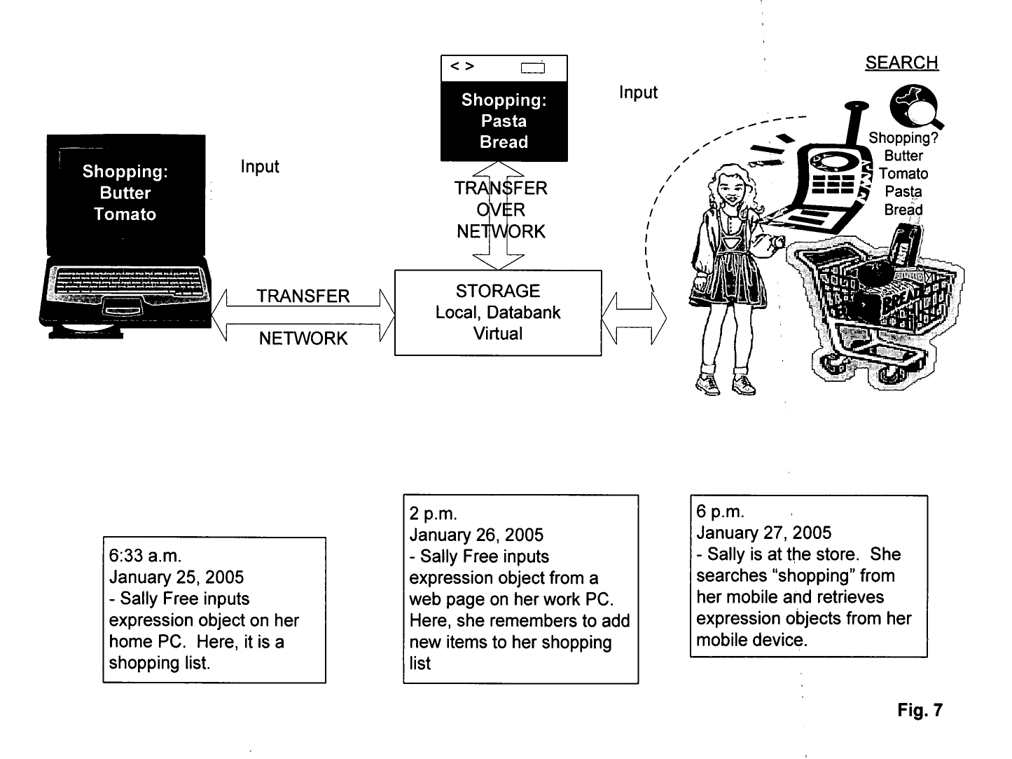

FIG. 7 depicts an example of how this technology may be used. FIG. 7 describes a useful user application resulting from the integration of some components described herein including free expression, a relational data model, permanent memory, a ubiquitous user interface and usage of tags.

A user may define an expression (in the form of a tag), associate to the tag a list of other expressions, and later eventually from a different device, further associate expressions to the tag. Finally the user can query the expressions associated to the tag (now all contained in the permanent memory) from yet another device. FIG. 7 depicts a case study of a shopping list that is a common task of many individuals. On Monday, on a PC, the creator defines <shopping> as a tag, and associates to the tag a list of shopping items (butter, tomato). On Tuesday, on a web browser, the creator associates to the tag <shopping> an additional list of shopping items (pasta, bread). On Wednesday, on a cellphone while at the store, the creator queries the <shopping> tag, and the permanent memory of the creator is queried, and returns the list of shopping items associated to <shopping>. That information is retrieved from the storage associated with the creator, such as a permanent

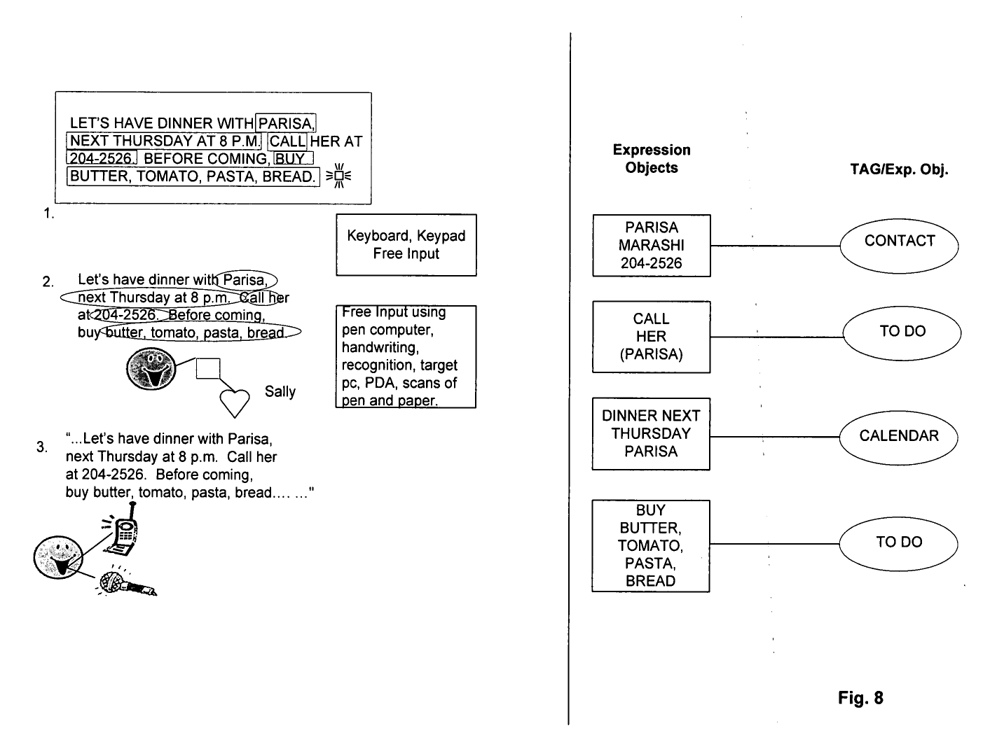

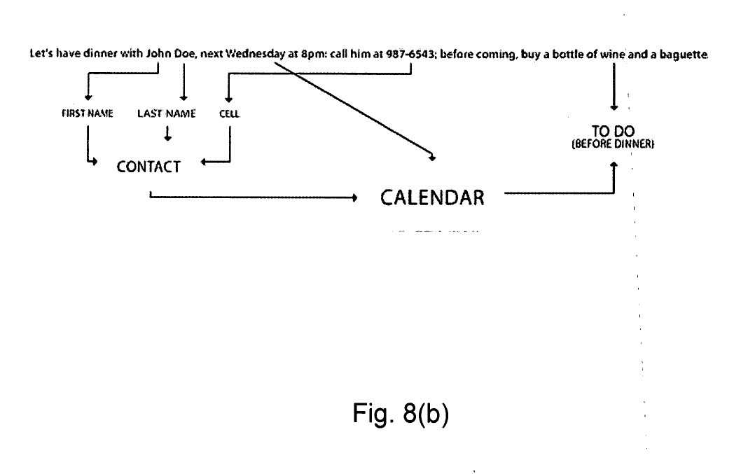

FIG. 8 depicts how an expression, the selection of parts of it, and the association to tags can be done using any creator input channel. This includes a type written input (1), a pen based input (2), and a voice based input (3), where all input can be transformed via algorithmic or user supported text and natural language recognition into the same natural language expression. The parts of the expression can then be associated to tags that are or had been previously defined in likewise manner.

FIG. 8(b) describes an example of organizing a personal note into tagged sections that may be searched and located regardless of application in which it was created.

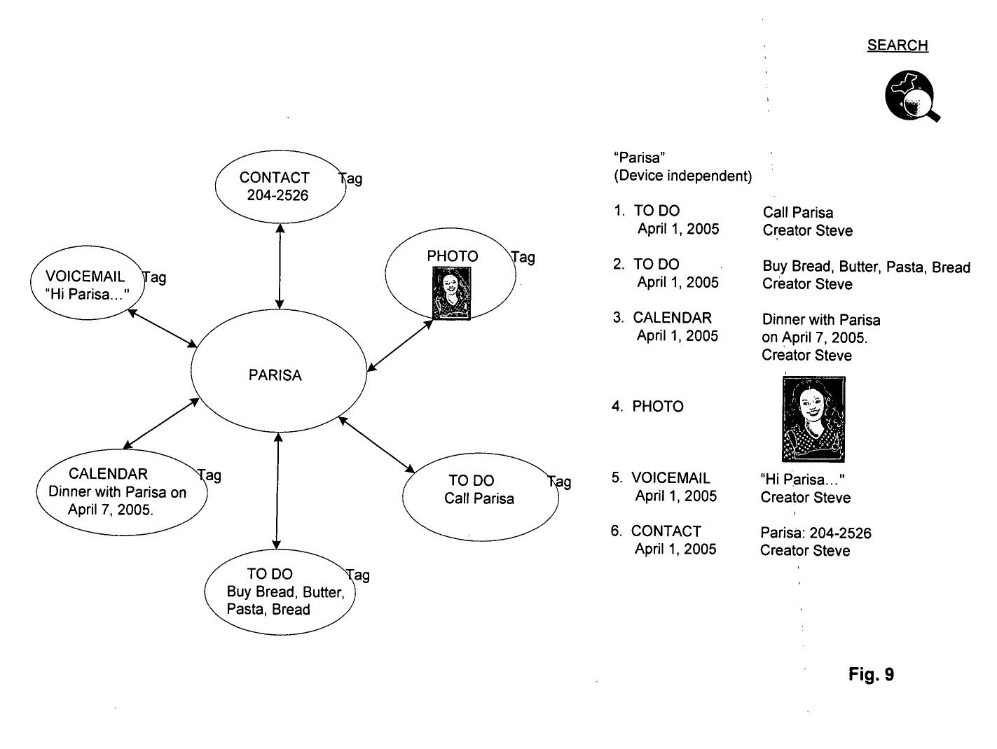

FIG. 9 depicts the graph of the expressions or tags associated to one selected tag or expression. This enables to perform a search by a tag, and to access all expressions that are related to said tag, and to display them in several ways, for instance sorting them by the time identifier of the expressions.

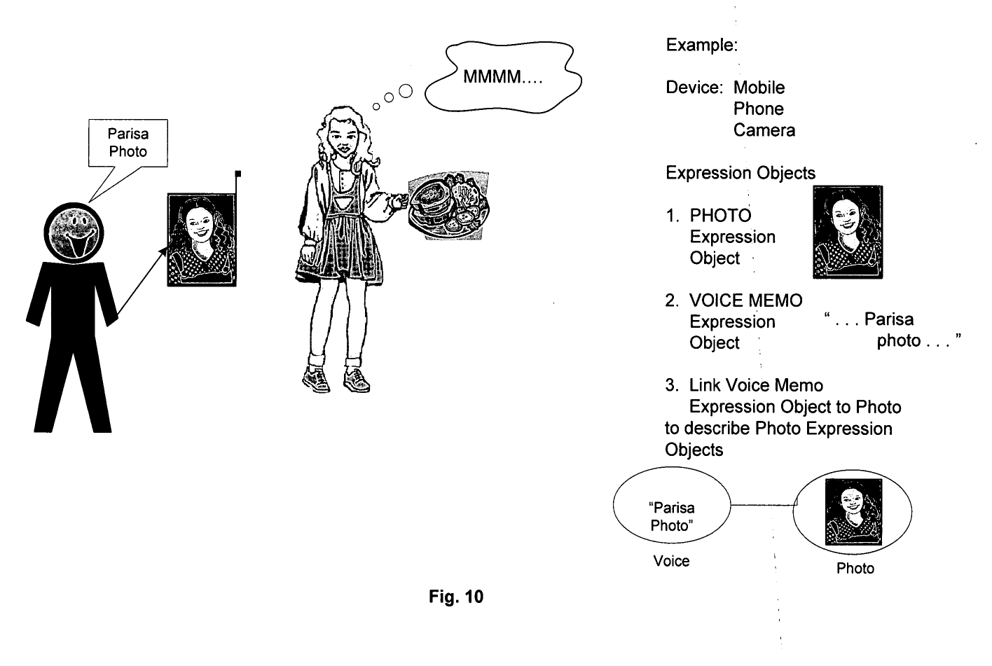

FIG. 10 describes how it is possible to perform multiple parallel expressions, and to associate such expressions. A creator takes a picture of a person, while recording a voice memo, then associates the picture to the memo, and further associates the picture to the tag referring to the person in the picture.

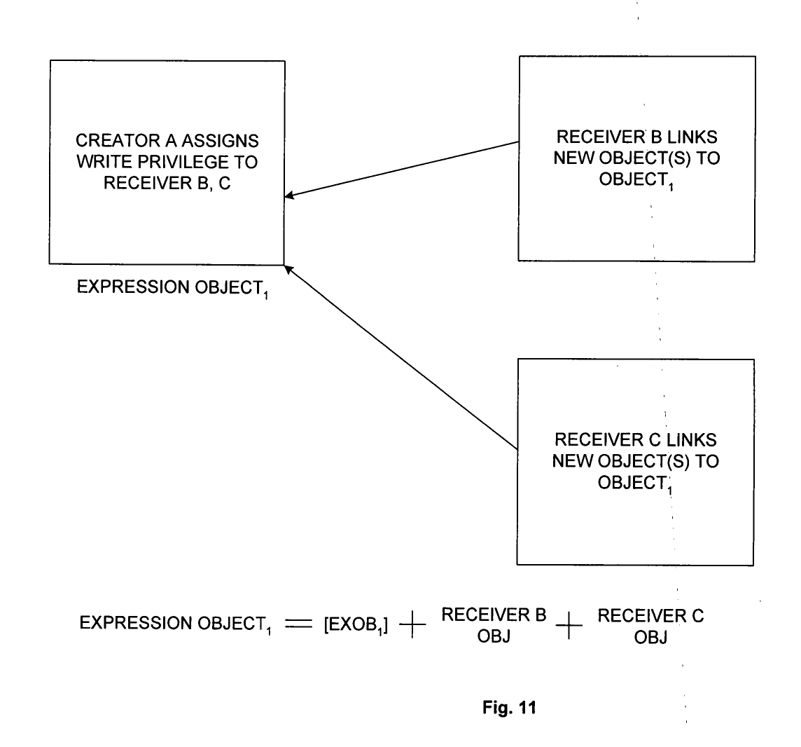

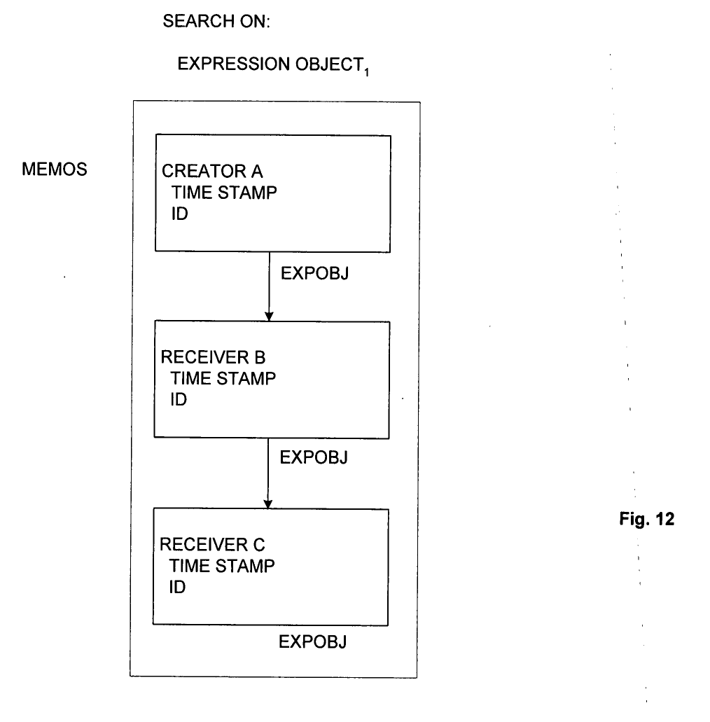

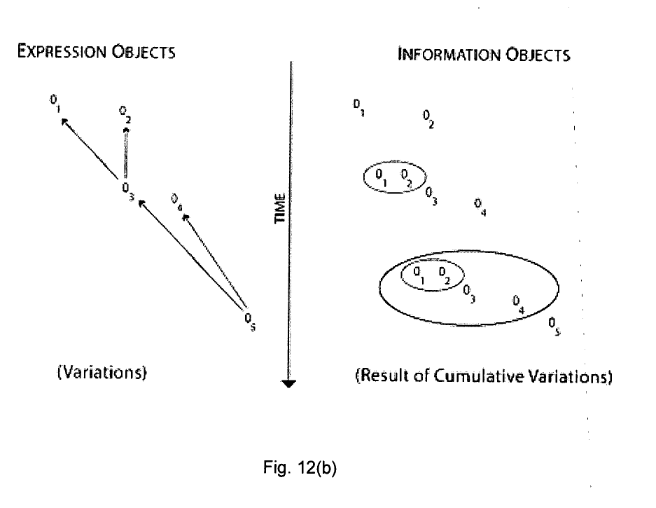

FIGS. 11 and 12 depict a schematic indicating that an expression object, here expression object, that may be created by a creator A may have related expression objects based on use of the expression object by others in their expressions. Here, creator A may have assigned write privileged to receiver B and receiver C, each of whom may have created a new expression object using expression object, as the basis through linking or incorporation. Then, upon search, in FIG. 12, that retrieves expression object, the results may also provide access to all related expression objects.

According to another embodiment, a permanent electronic memory of a person, or “extended brain memory” may comprise the collection of all information that is accessed and expressed in life. It may be physically or logically centralized storage accessible by the person for its lifetime. Central storage can be realized even in absence of the other inventions, but the input and data models support it as powerful and efficient extension of brain knowledge, while overcoming the mentioned information technology problems. FIG. 12(b) describes how efficient storage needs to be primarily based on expressions (variations of information) instead of the replication of completed products.

Embodiments of the present invention diverge from existing information technology thinking but also works with current IT to transition away from it. It adopts the rules of interaction among humans: therefore, it will be more natural to learn, especially by children, seniors, and whoever has not adapted or been exposed to the information technology of today.

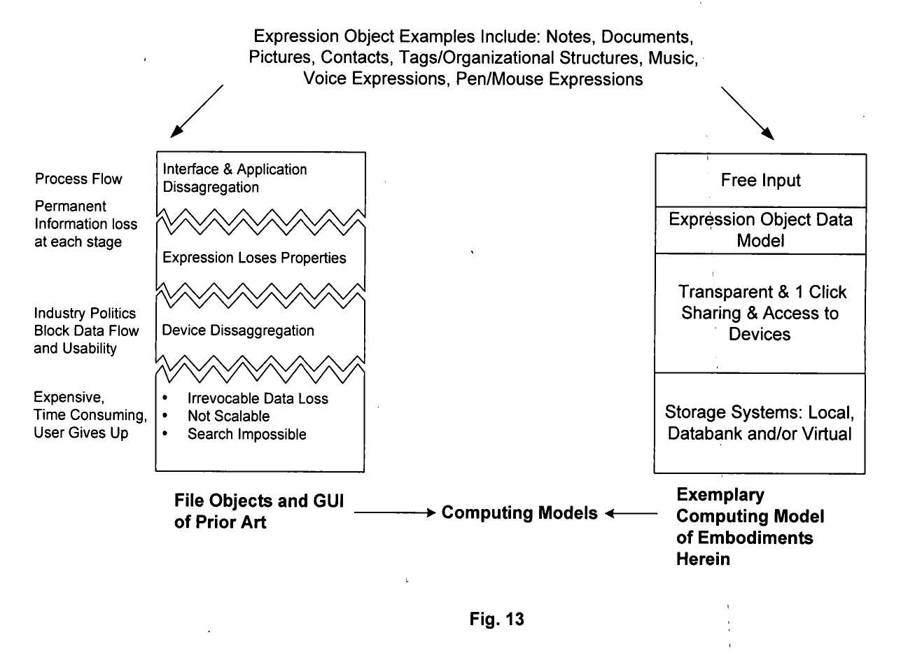

FIG. 13 describes one possible computing model (right) that can be derived by using the embodiments herein, and how this model would solve some structural problems of the information technology state of the art, which is based on graphical user interfaces and file objects. A user expression fed into the state of the art information technology has the shortcomings indicated on the stack. A user expression fed into the exemplary computing model would have those problems eliminated.

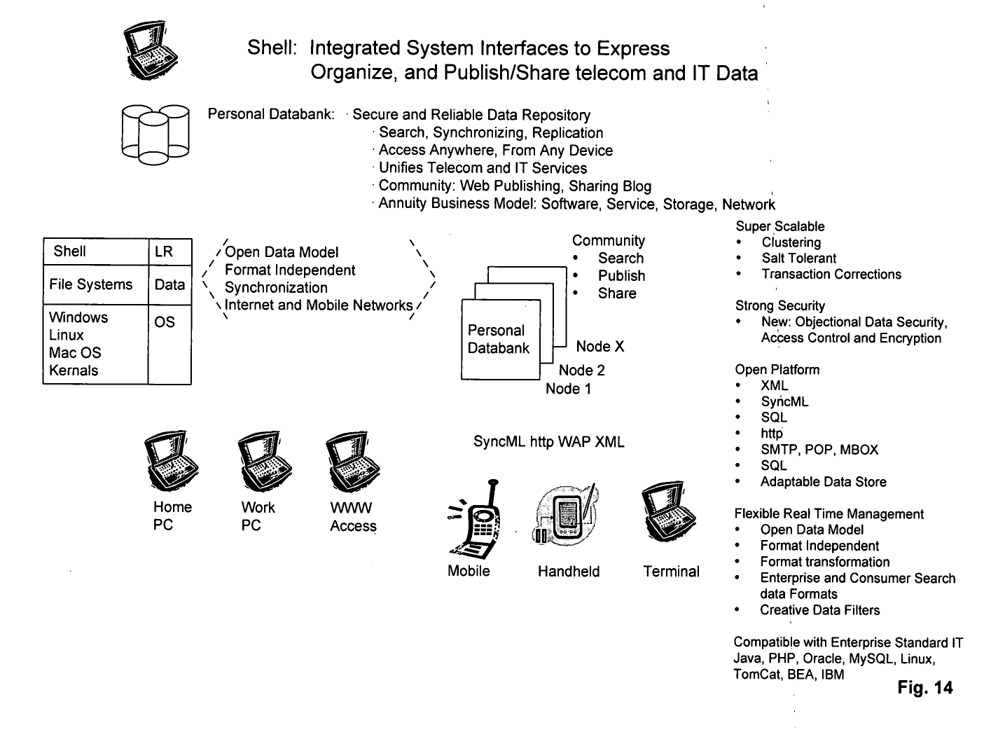

FIG. 14 depicts the components of an architecture that enables to express, organize, search, publish/share, access and display integrated data from Information Technology and TeleCommunication services. The shell is the core user interface on the client device that can run on any computing device operating system using any file system. The client device talks to personal databank via the Open Data Model, independently of file formats, using synchronization technology, over any data communication network available. The personal data bank is a secure and reliable repository of integrated data from any information technology or telecommunication service, that can be accessed anywhere from any device, via any communication network. The data bank technology has a list of features listed on the right, that enable scalability, security, openness to formats, flexibility, and compatibility to existing technologies

In various embodiments of the present invention, IT becomes an extension of the human brain through a model that supports data flowing from and to people. The following components may be implemented to enable IT to operate as the extension of the brain.

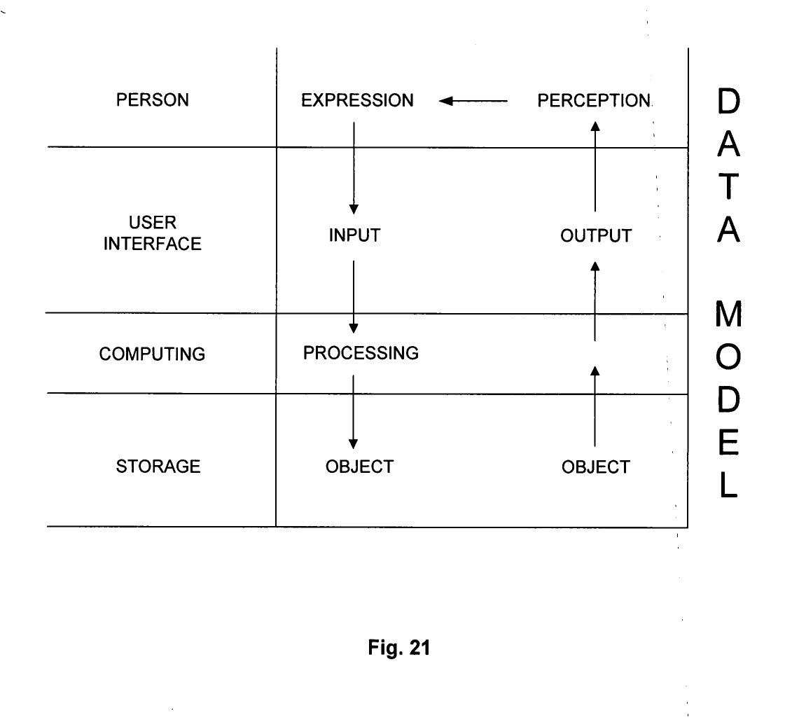

FIG. 21 depicts a model of main components of IT and how they are related with respect to the user. The data model described herein may explain the basis for allowing data to flow between IT and humans.

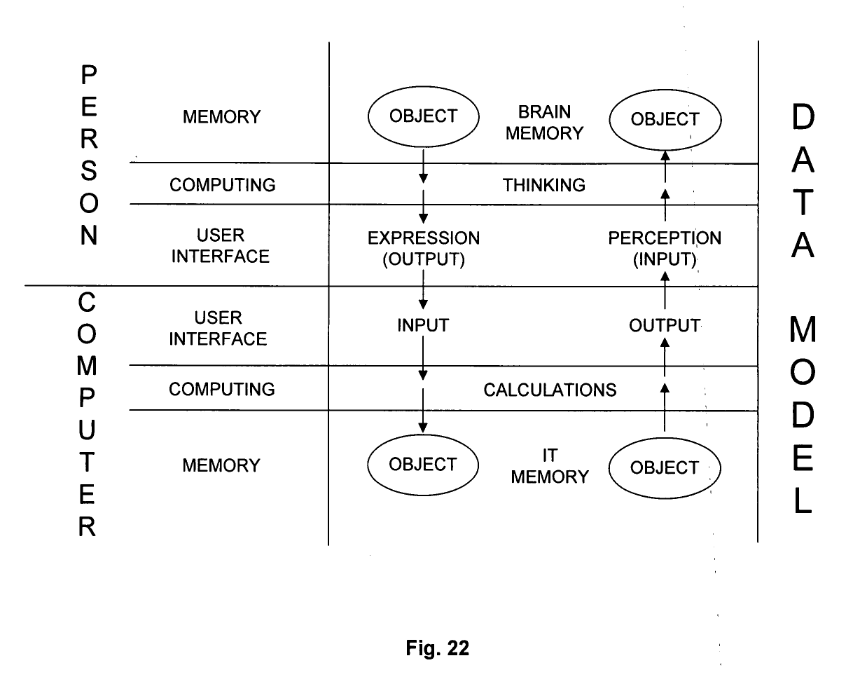

FIG. 22 depicts an exemplary model for components of both IT and humans, and how information flows. The specific components and relationships are addressed below.

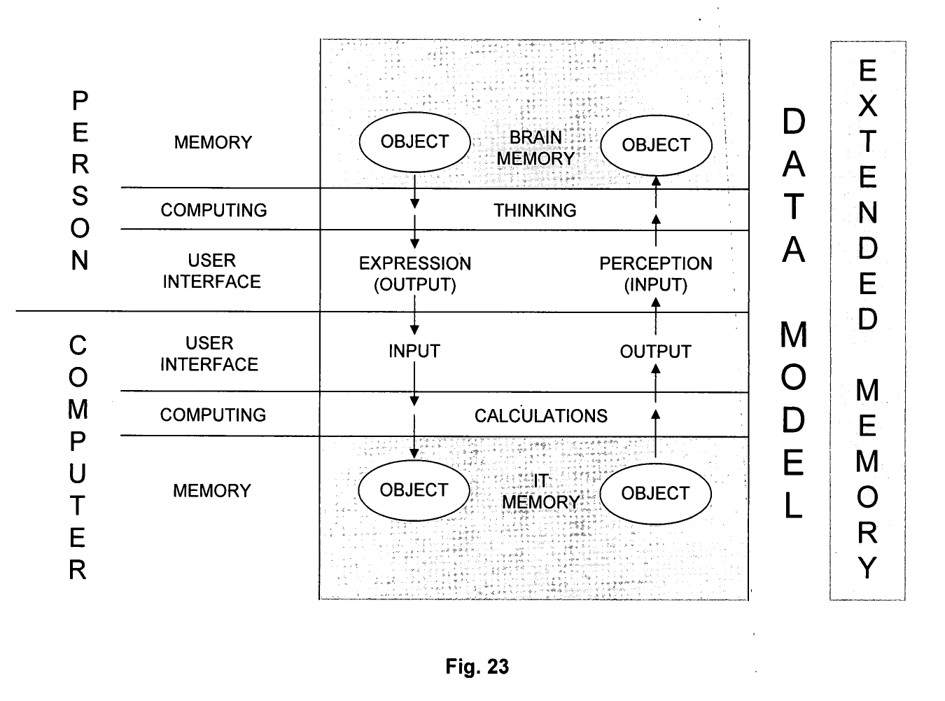

FIG. 23 depicts an exemplary model according to embodiments herein showing the extended brain memory and how the memory of a person can be the sum of the information objects in the brain and in the IT storage.

Progress in electronic storage has achieved the threshold that allows storing virtually any action of human beings. The next leap of humanity is to make information technology the extension of the brain, where all life actions and expressions are recorded. Instead, current electronic storage is clogged with countless repetition of disorganized information with wasteful file encoding (e.g. a 5 MB PowerPoint file with a few lines of text flying and sparkling, which contains a few KB of content). To make all the recording possible and useful, we need to support its organization.

In order to make information technology the extension of the brain, we have developed a model that supports data flowing in eternal evolution through all processes, to the human brain and back into information technology. Instead, in the current model of information technology, data suddenly interrupts its cyberspace flow into paper, redundant copies, or system restrictions. Social innovations will be needed for the extended brain to blossom: notably, the social rules that apply to information in our mind need to extend to the electronic memory. The following image describes the main components of information technology and how they are related with respect to the user.

The extended brain model of various embodiments allows a person to record any desired information, and determine what constitutes an information object, associate information objects in desired relationships, make wanted information available anytime, anywhere, to anyone allowed, apply the social and legal rules to that humanity has developed for the mind, view, manipulate and associate information to produce new information, and/or avoid reproducing information, but create and innovate.

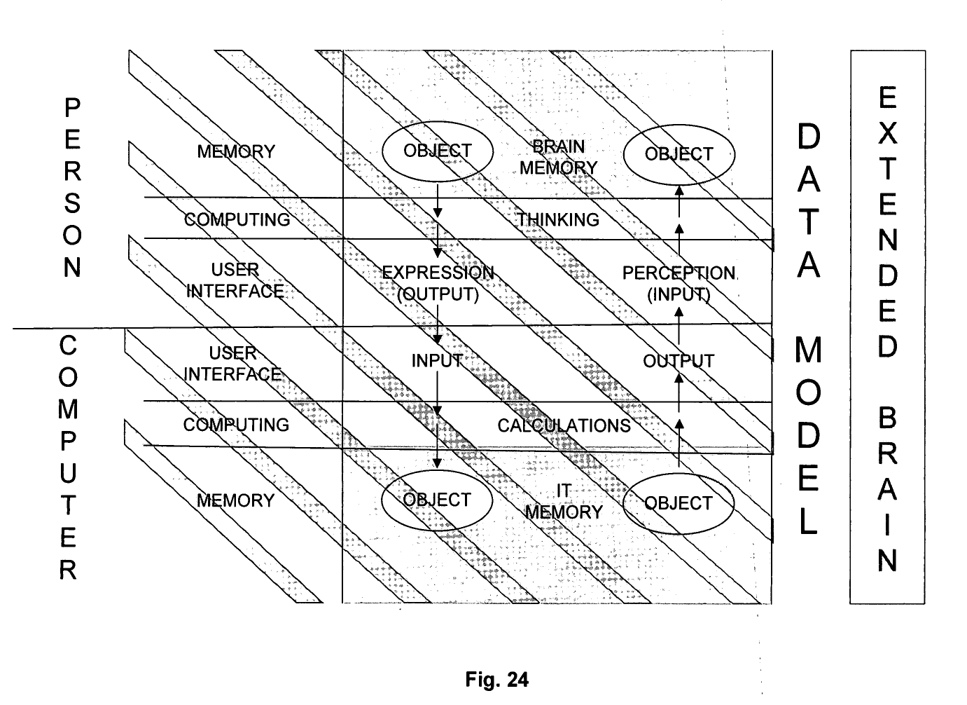

FIG. 24 illustrates an exemplary model showing the extended brain as the sum of the brain plus IT memory and processing.

One aspect of various embodiments of the present invention is that data may flow in an eternal evolution through the extended brain. Data may flow digitally through all processes, to the human brain and back into IT. Instead, in the current model of IT: data suddenly interrupts its cyberspace flow into: replicated paper copies, and/or user interface to a person. In prior systems, IT was constructed without the confidence that IT could handle all of the data for which it was designed.

Data Model Section

Open Information Object

One embodiment and an element of other embodiments described herein may be an improved electronic data model. One component of the data model may be an “Open Information Object” or “OIO”. The open information object is also used to embody: the expression object of a person (or a software, or an other OIO) and relate expression to existing data.

An OIO may have a number of properties, including the relationships to other information objects and people (who are also represented as OIOs). An OIO may be the composition of other OIOs with a novelty.

An Open Information Object may be understood to be a complete unit of information with a set of components. Components may include a novelty, other OIOs previously built, and other properties.

In one embodiment, the OIO may have one or more of the following components: creator, creation time, identity, access control, novelty, parents, relevancies (of links and novelty), and access log

Creator may be the entity that created the novelty: a person, by producing an expression object, a software program, an other OIO. The creator may also be identified as an OIO, whether it is a person or a program.

Creation Time: OIOs contain a time stamp that corresponds to the time of its completion. In one embodiment, the time stamp may not be changed.

Identity (eternal): each OIO may have a permanent logical electronic identity, so that it can be eternally identified and located. An eternal identity prevents the problem of broken links. The problem of “not wanting to be accessed anymore” can be addressed with access control. This may also solve the waste of time of cut and paste. (A method to assign an eternal identity is specified elsewhere.)

Access control: each OIO may have its own access control values. The access control is assigned by the creator. Any OIO (person or information) that is in the access control list can use the OIO. (Access control is explained in detail separately.)

Novelty: the novel content that is the result of the production of a creator: an expression of a person or a calculation of a program. The novelty can be at the least a series of links to other OIOs. The novelty may also be the action of requesting an exact copy of a selected OIO.

Parents: the OIO may be a composition of novel content by the creator, eventually using or pointing to existing information. At the minimum, the OIO is the expression by a creator of the relationships among existing objects. Parent objects may be those component objects that are used or referred to, and are indicated as OIOs of level-1. Notice that the OIO may or may not contain a copy of parent OIOs.

Relevancies: the relative contribution of the novelty and the parents to the OIO. The relevancies may be attributed by the creator, but they could be also defined by other entities. The relevancies are calculated in a scale (e.g., 0-1 or 0% to 100%, the sum of the relevancies being respectively 1 or 100%).

Access log: may be the log of all requests or usage by other OIOs. (The access log and related methods are discussed elsewhere in detail). The access log indicates a record for each request, including the calling (child) OIO and the time of request.

The components of an OIO may be an integral part of it for its lifetime in one embodiment, although it is possible that such components could change as improvements in IT change.

In addition, OIOs may also have the following additional characteristics in various embodiments: undeletability and auto-safe. Specifically, an OIO may be undeletable voluntarily. It may be thought of like the information in the brain that can not be deleted at one's will (one can not decide to forget something). Indeed, the concept of deleting information is unnatural to humans. What people usually want is to be unexposed to information they do not want, or to prevent the information to be available to certain individuals. It is not their prerogative to have the information deleted. When one does not want others to know something, they do not communicate that, but they cannot delete it from their brain. Indeed, it has been common practice since the recording of information on paper that verbal information is volatile, while paper information is to stay: people communicate verbally things that they do not want to be misused.

In addition, OIOs may be automatically saved without explicitly indicating so. The indication of completion of the OIO is the maximum time needed to have information permanently defined in electronic memory. The concept of “saving” writing is new to humans. When a human has written on paper she does not have to do anything else. An expression may be saved before being completed into an OIO if longer than the set auto safe increment. In other words, in case of an expression, the expression is saved automatically in the memory system, and the person can also determine when an expression is turned into an OIO.

Open Information Object Relationships

An OIO may be built at a specific time based on previous OIOs and a novelty. This creates a genealogic or temporal graph. The genealogic graph may represent cause and effect, and evolution and may be acyclic because it may be temporal.

On the other hand, at any given moment, there exist multiple objects, that may have relationships among each other. The relationships at any moment in time create a network graph of the information space at a given time. The information space network at a specified moment in time may be non-temporal and may be cyclical.

One or more of the following actions may be done: store each action and variation, store the state when requested, and/or store the state of the art.

For instance, a person may want to record all inputs, thoughts or whatever, as they are produced. Then she may want to structure them (saving these changes of state), and create a snapshot of certain states. These are documents, or specific states (see cyclic).

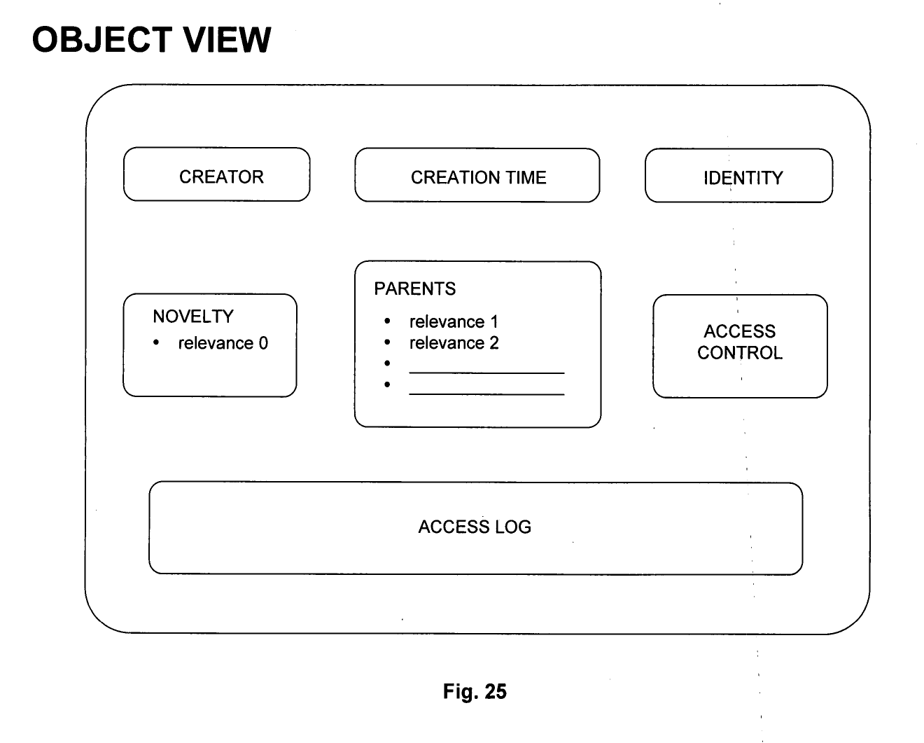

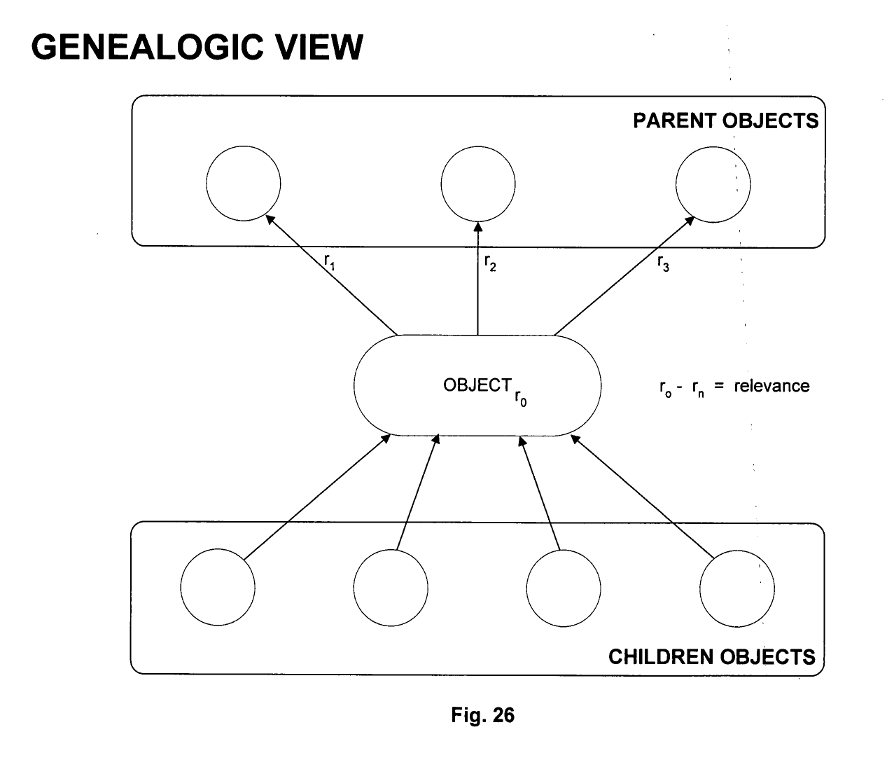

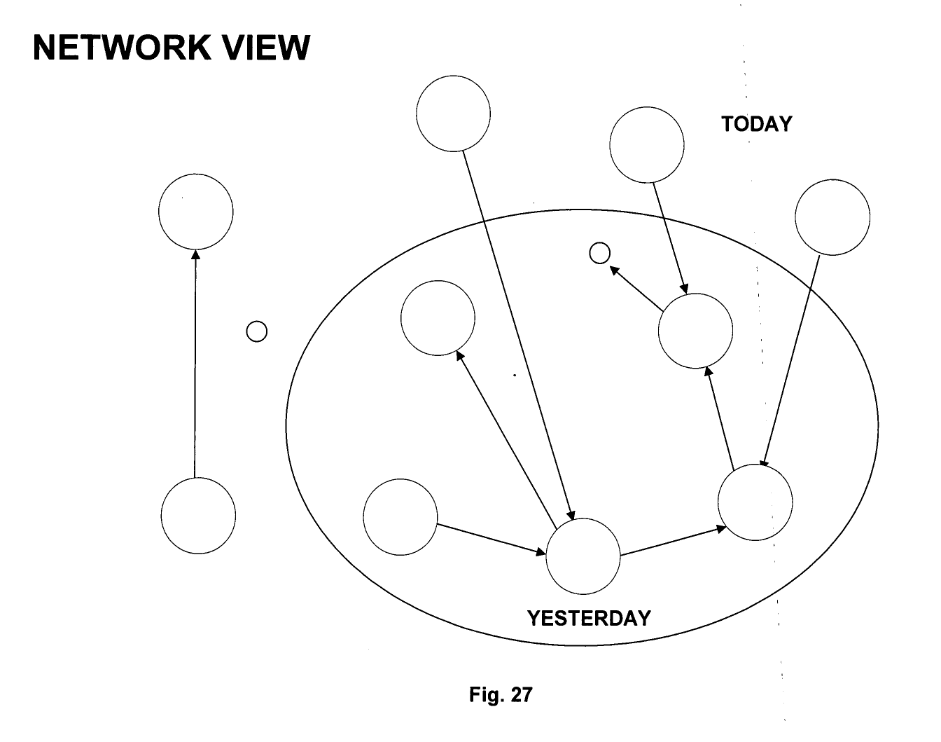

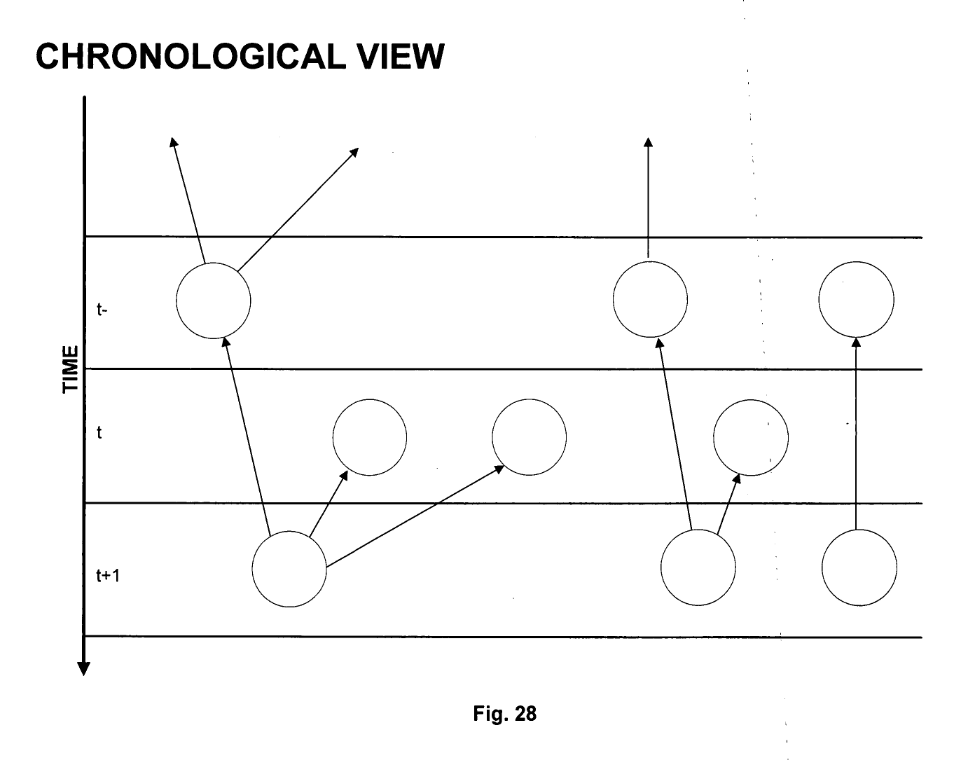

Some additional drawings are provided to assist in understanding these elements. Object view (see, e.g., FIG. 25): represents the components of an OIO (described above). Network view (see, e.g., FIG. 26): represents the relationships among multiple OIOs at a given time. Genealogic view (see, e.g., FIG. 27): represents the genealogy of an OIO, with respect to parents and children. Creator's view (see, e.g., FIG. 28): represents a creator of multiple OIOs. Each object has a counter that collects the hits. The hits may also be transmitted to the component objects (maybe of others). Also, the multiple objects of an owner may increment the cumulative counter.

The OIOs linked by the OIO in consideration (are called parent objects). The objects that are linking to the OIO in consideration are called the children OIOs.

As stated above, the OIO may comprise a novelty and the parent OIOs. It is possible to assign relevancies of the parent objects and the novelty. The relevance r_{—}0 may be specified (or even in some instances mandatory) if novelty is required. The total relevance is 1, or 100%. Different entities may assign the relevancies and other specifications of OIO relevancies as described elsewhere.

In one embodiment, where an OIO is permanent and contains a novelty and possibly a link to existing OIOs, this creates a growing network. The network view of the OIOs in existence may be depicted as a graph such as in FIG. 26 (showing objects at two subsequent times).

The chronological view (FIG. 27) may show the network of OIOs displaced on a time scale of creation.

The creator's view (FIG. 28) may show the OIOs that a person expressed. Each OIO has an access log. The creator can view and collect the logs of all created OIOs.

Accordingly, these various embodiments may provide a method to create open Information Objects, comprising the steps of: capturing an expression, selecting at least two existing information objects, defining a new open information object as the set of address identifiers to said relational operator and said expression objects, creating an access log, creating an access control, assigning a time identifier to said new information object, wherein said time identifier is a moment in time between the earliest of the time identifiers of said expression objects and the moment in time of defining said expression, assigning an owner identifier of said expression object, wherein said owner is said person, and/or creating a electronic address identifier to said expression object.

In addition, this method may allow defining relevance of the components information objects (and added value), copying the existing objects into the new objects and use of an access log and/or control.

Free Expression and Input

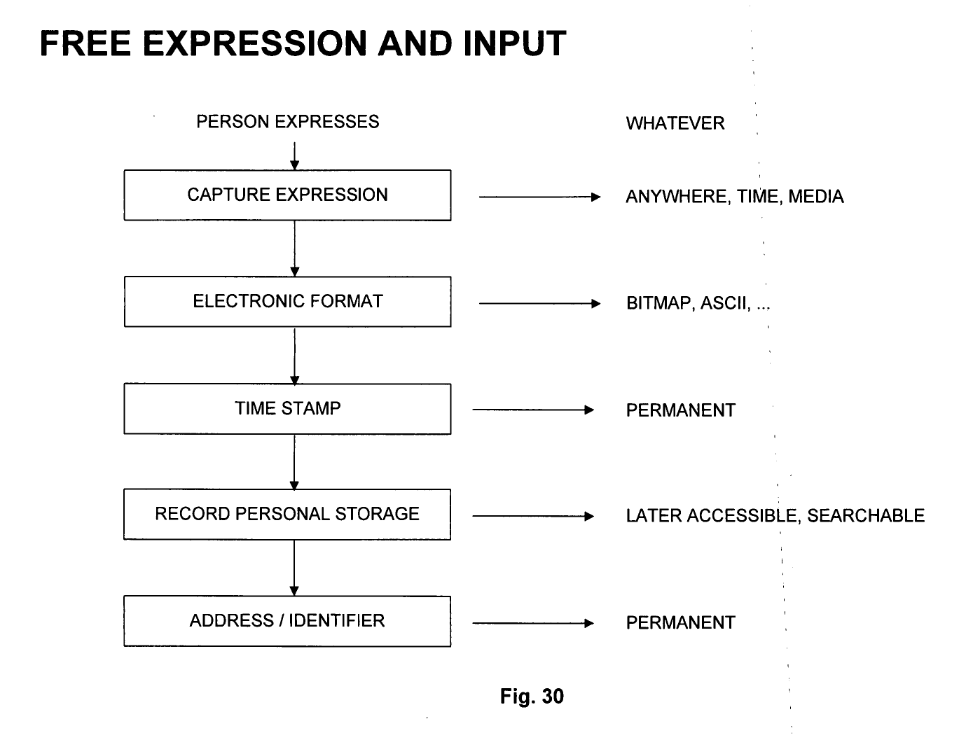

Another element and embodiment of the present invention involves “free expression input” as part of a response to the mentioned problems. One embodiment of a method to input and store free expression may comprise as shown in FIG. 30, capturing any desired expression, inputting the expression in an electronic format, time stamping the expression; recording the expression in electronic memory, and/or creating a permanent address identifier to the expression.

Through the various embodiments, the expression may be later: found, accessed from memory, and/or elaborated into some different form.

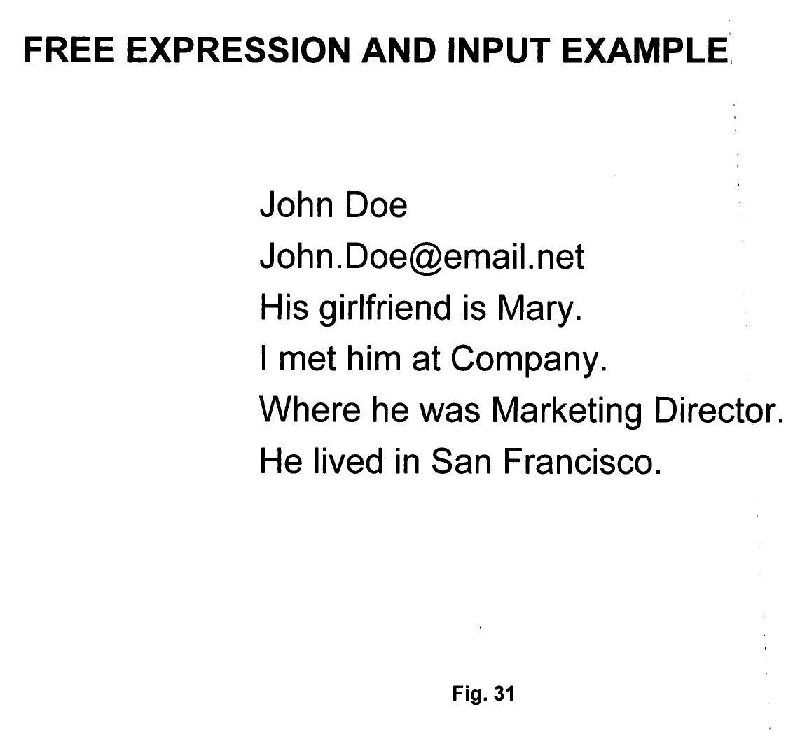

In one iteration, the user is not restricted as to about what, how, how long, and when an IT user shall express information into electronic media. Expression may occur if and only if the user wishes, and, if desired, without the need for specifying to “save” the information. Consider the example of FIG. 31 as a free expression input for the following discussion.

Expression Object

An expression object may be a complete expression unit as decided by the person (or software) who expresses it. An expression object can be encoded using the OIO model. Also a person and a software program can be an OIO. Therefore, an expression object may be an OIO and may be created by an OIO.

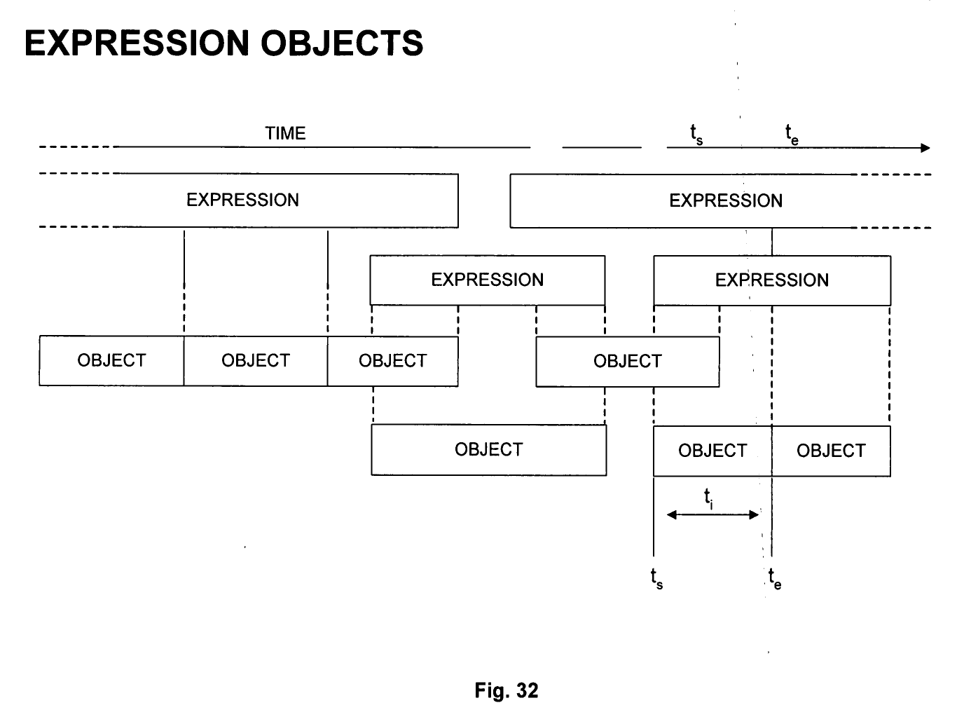

An expression object may have a starting time t_s and an ending time t_e. So an expression object may comprise the part of an expression produced in the time increment t_i=t_e−t_s (see FIG. 32 for example).

An expression may be: one expression object, and/or composed by multiple expression objects.

An expression object may be as atomic as a word, or as complex as a software program. In one embodiment, it is up to the creator to decide what an object is, and how to break up expression in complete objects. An expression object may be decomposed into new multiple expression objects after expression as discussed below.

Examples of expression objects: a word, a number, a sign, part of a spoken sentence, a photograph with a caption, the face in a photograph, a composed sound, the relationship between two sentences, and/or a user interface action captured by electronic media.

An individual can produce simultaneous expressions: for instance, writing text, while speaking and being recorded by a video camera. An expression object may be the smallest unit of expression that the creator decides to be complete and self-contained. The start time t_s and end time t_e (or increment t_i) can be set in one of the following ways, as an example, although other ways may also be used. The creator decides t_s and t_e or t_i in real-time. This means that the creator decides in real-time what constitutes the completion of the expression object. Second, the creator may determine any predetermined values for the expression.

The minimum possible time increment may be determined by the existing information technology and the type of media. At the limit, it is possible to consider an expression object as the expression at one point in time. Exhaustion of storage capacity or malfunctioning of equipment may also determine the end time of an expression into an expression object. An expression object may be encoded using the OIO model and in this embodiment, the expression object may comprise part of or the entire novelty portion of the OIO.

A person, a software program or some combination may be the creators of an OIO. A person can be referred to as an OIO. Also a software program can be as an OIO. Therefore, an expression object is an OIO and can be created by an OIO.

Accordingly, these embodiments may provide a method to electronically manage expression, comprising: capturing expression of a creator, transforming said expression in electronic format, defining an expression object as the expression between a selected start time and a selected end time, wherein said start and end times are determined by the creator, assigning a time identifier to said expression object, wherein said time identifier is a moment in time between said start time and said end time of said expression, assigning a creator identifier of said expression object, wherein said creator is said person, and/or creating a electronic address identifier to said expression object.

It should be appreciated that the expression media may comprise: text, voice, image, sound, video, etc. that there may be: multiple simultaneous expression objects, that the start and end time may be predefined, automatically defined or subject to a default determination, that the voluntary expression may comprise: writing, drawing, etc., and that the involuntary expressions: may comprise action log, video camera, etc.

Chronological Memory of Expression Objects

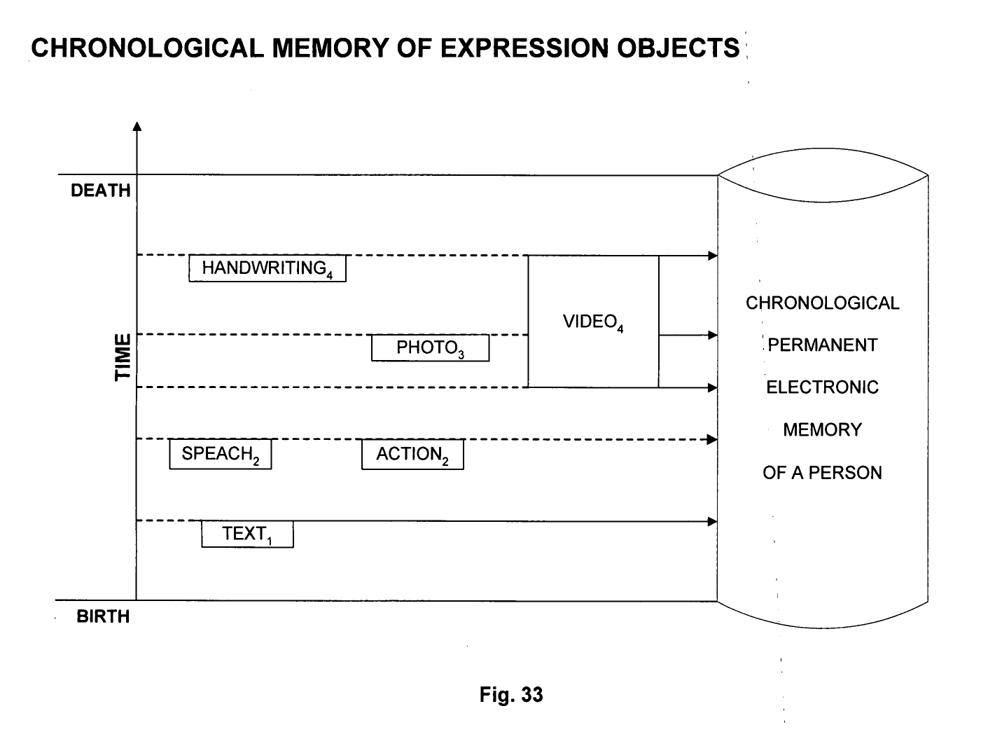

FIG. 33 depicts an embodiment describing how production of expression objects of a person has a natural chronological order, from birth to death. A person should be enabled to permanently memorize expressions in a chronological personal electronic memory. FIG. 33 shows how different expression objects of different media (text, video, photo, speech . . . ) may be simultaneously produced and memorized in the chronological permanent electronic memory.

Expression can be permanently memorized, if and only if the user wishes. As one embodiment, if the person decides to memorize an expression object in the chronological personal storage, then it may then be undeletable. Once the expression is completed into an expression object, it may be memorized with the time stamp of completion.

Expression Types

Expressions may be voluntary or involuntary, and may involve multiple types of media.

Expression media may include, for example: text, such as typed on a computer keyboard, sound, such as speech recorded by the phone system, graphic, such as a digital photo, video, such as a video clip, and numeric, such as the measurements of blood pressure.

Voluntary expressions may include, for example: writing, drawing, speech, and thought (future) when possible record directly from thought.

Involuntary expressions include, for example: an action log, for instance the positioning as recorded by GPS, an x-ray at the hospital, and/or a security video camera recording.

Ideally, a person shall have the creatorship and access control rights to involuntary expressions, but that may change in different embodiments.

In addition, the methods and systems employed may distinguish: speech (such as a person talking) from audio (such as a music composed by a person), photo (picture of a person) from image (such as a drawing or illustration by a person), and/or video (person recorded on video camera) from movie (such as animations composed by a person).

A detailed description of the expression components is specified below for handwriting and speech.

Decomposing an Expression OBJECT

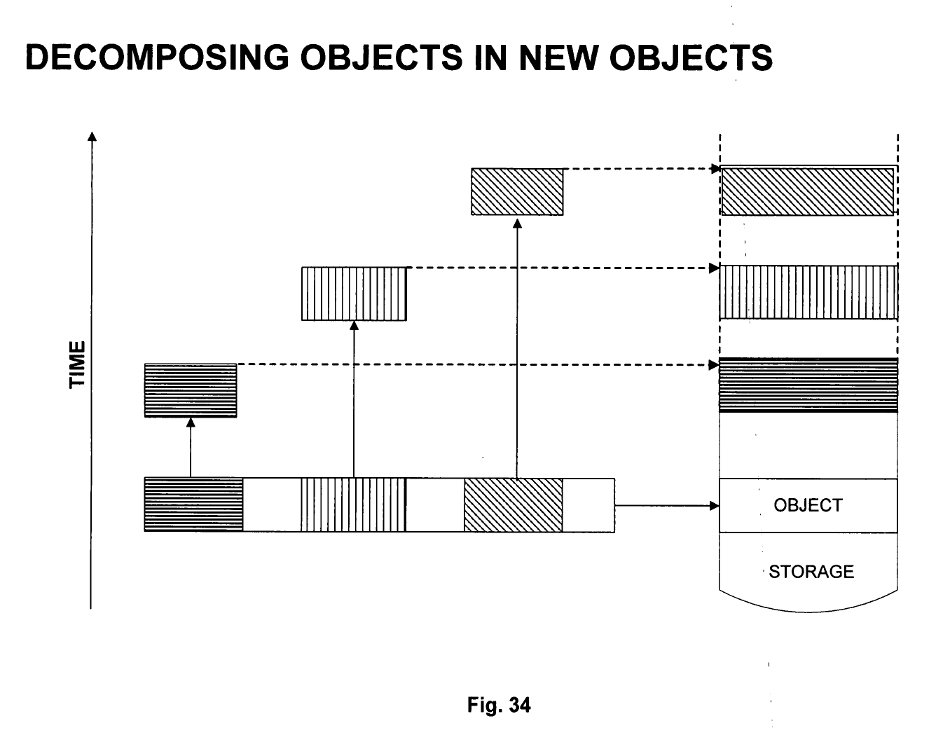

FIG. 34 and the following example show a method to elaborate a previously expressed object and generate new multiple expression objects comprising: an expression object (previously expressed and electronically memorized) is fetched, a part of the object is selected, it is defined as a new expression object, and it is stored in personal electronic memory.

Similar text can have a different structure. For instance: a user could write a note: “I will meet at 3 pm John.” which is an expression object. The user could then structure the note into smaller objects:

<what>I will meet </what><calendar> at 3 pm</calendar> <John Doe> John </John Doe>.

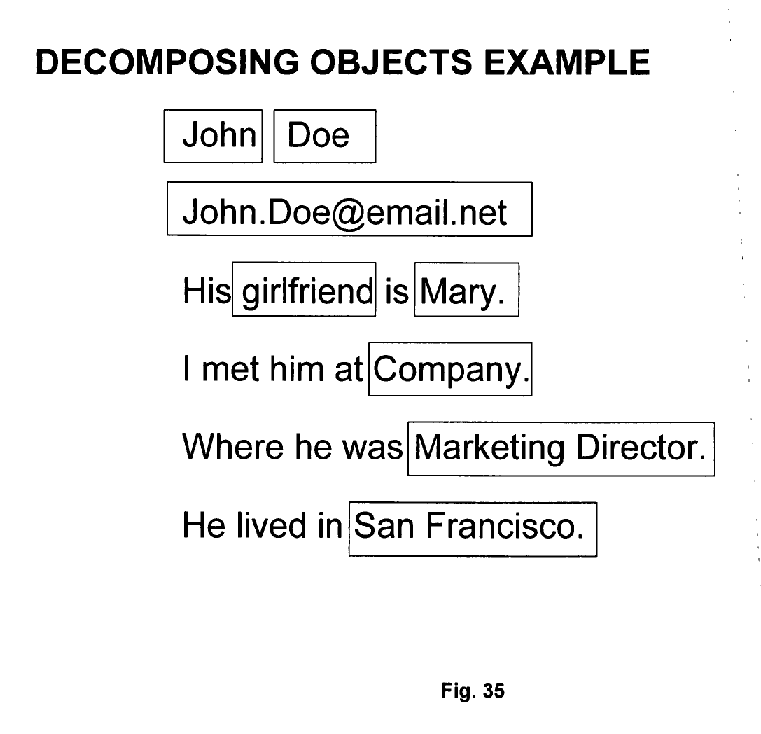

The user may express an indirect text of someone else: “He said: ‘I will meet at 3 pm John.’” Another example of decomposing an expression object is depicted in FIG. 35.

Accordingly, various embodiments provide a method to electronically manage expression, comprising: selecting an existing expression object of a person, fetching said expression object, selecting a part of said expression object, defining a expression object as said part, assigning a time identifier to said expression object, wherein said time identifier is a moment in time between the time identifier of said existing expression object and the moment in time of completion of defining the said part, assigning a owner identifier of said expression object, wherein said owner is said person, and creating a electronic address identifier to said expression object.

Structuring Expression Objects

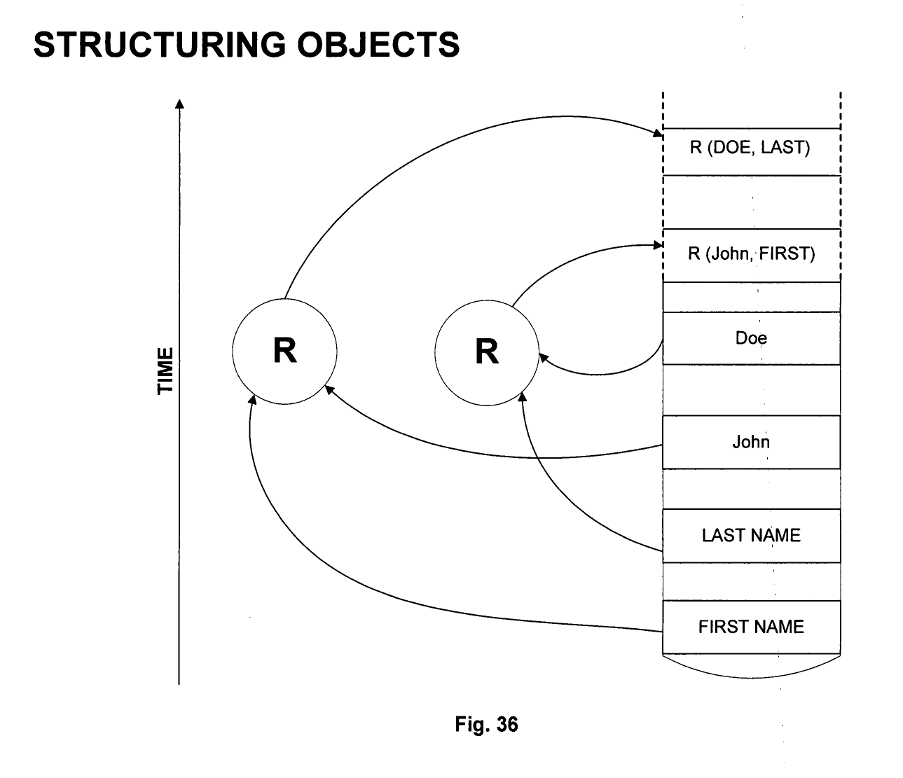

FIG. 36 shows how it is possible to assign a relationship among two previously expressed objects. The relationship between two objects may be an expression object. The relationship may have a pointer to the objects in the relationship, and does not typically store the objects pointed in it, although other embodiments may store those objects. Because the relationship among two objects may be an object, it can then be stored as an object in the chronological personal storage as well: an expression object is fetched, another expression object is fetched, the two objects are related, and the relationship is stored as an object.

Structuring may be an expression as well, that goes in the time log, and is actually the creation of a “link”

Accordingly, various embodiments may comprise a method to electronically input, structure and store personal expression that may comprise one or more of the following acts: capture any desired expression, input the expression in an electronic format, time stamp the expression, record the expression on electronic memory, create a permanent identifier to the expression, search preexisting objects, fetch objects, expressing relationship among two or more objects, input the relationship object, time stamp the expression, and record the expression on electronic memory.

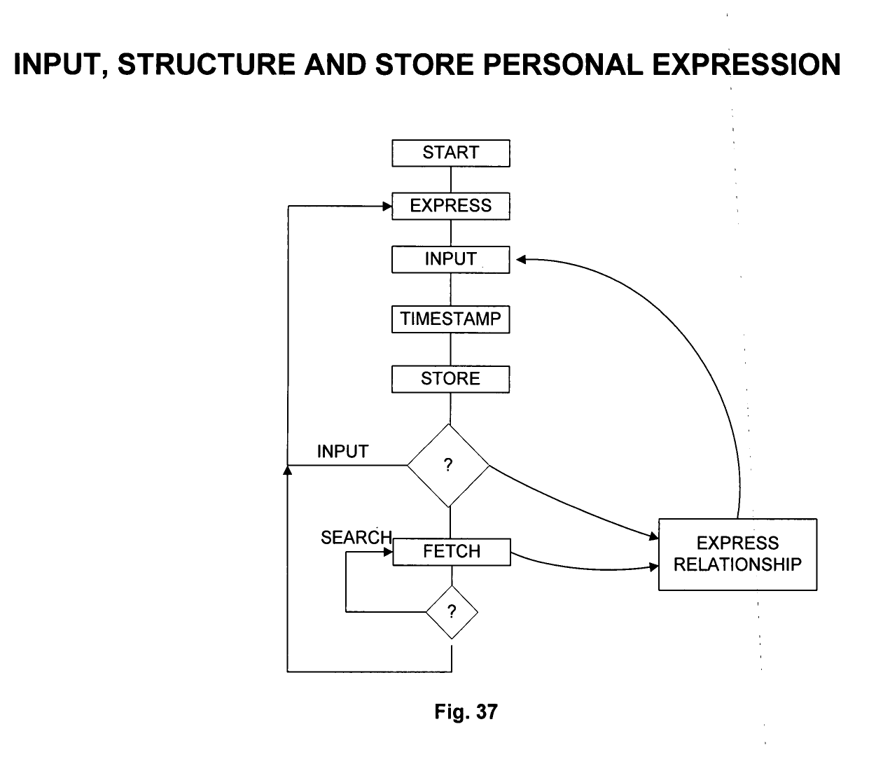

Various such embodiments are represented by FIG. 37.

Moreover, various other embodiments may comprise a method to electronically manage personal expression, comprising the steps of: capturing a personal expression of a person, selecting at least two existing expression objects, wherein the selection is done by said person, fetching said expression objects, selecting a relational operator, fetching said relational operator, defining a new expression object as the set of address identifiers to said relational operator and said expression objects, defining a new expression object as the set of address identifiers to said expression objects, assigning a time identifier to said new expression object, wherein said time identifier is a moment in time between the earliest of the time identifiers of said expression objects and the moment in time of defining said new expression object, assigning a creator identifier of said expression object, wherein said owner is said person, and creating an electronic address identifier to said expression object.

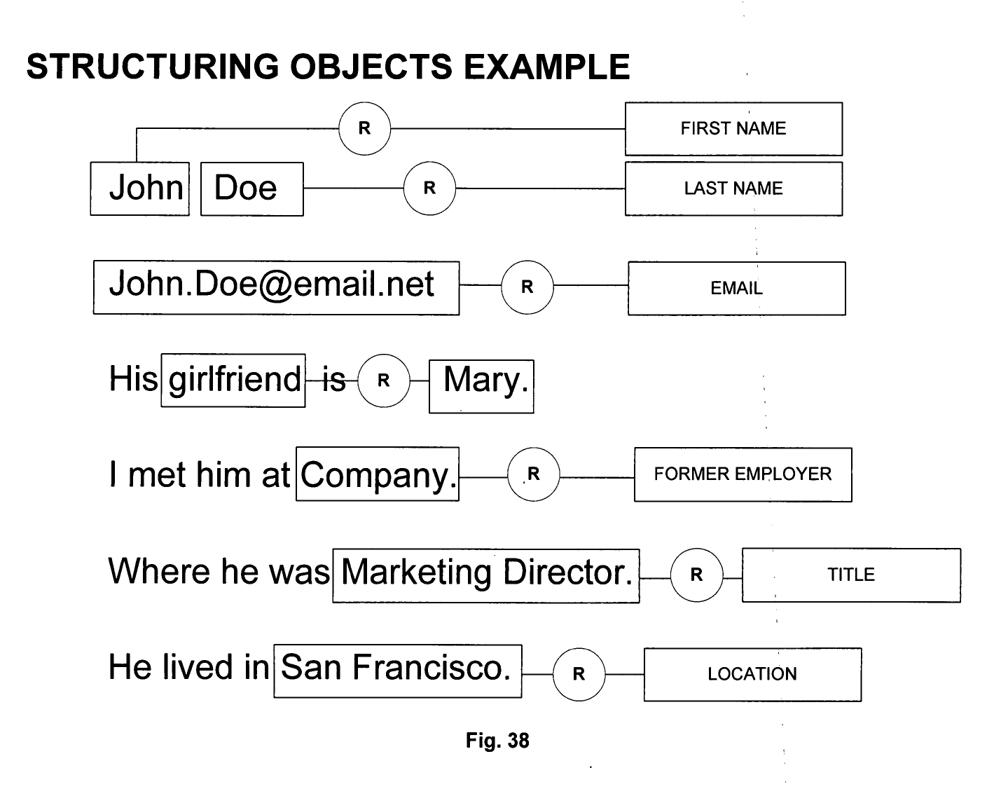

This method may also comprise: creating a new expression object while relating to an old expression object, and creating at least two new expression object while relating them. One such example is depicted in FIG. 38.

Expressing, Relating and Storing Expression Objects

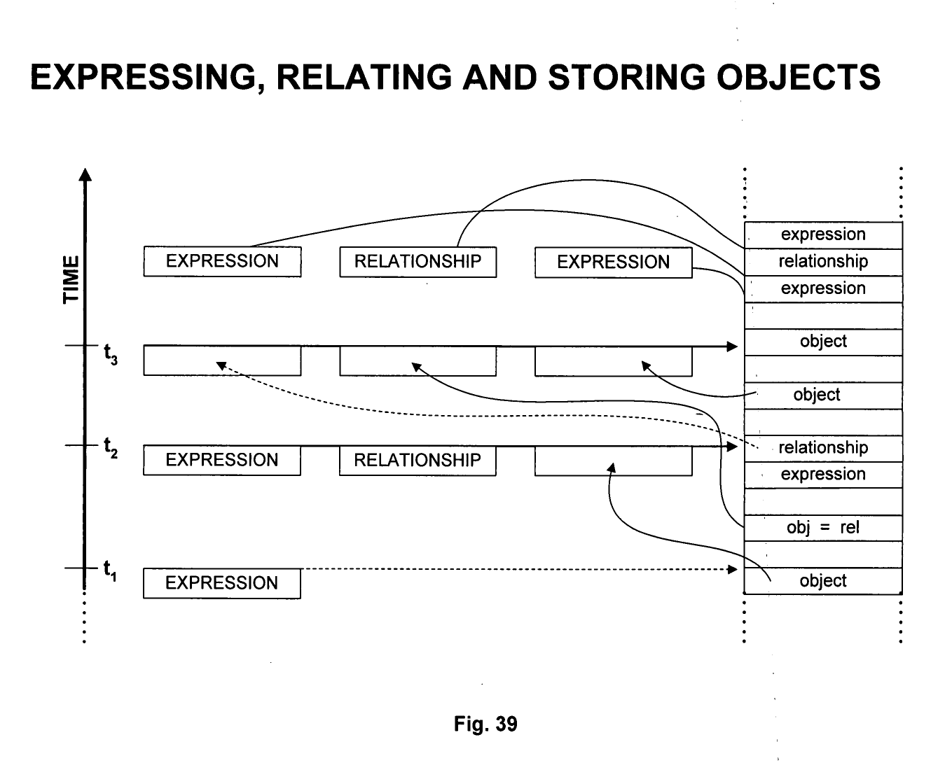

The chronological personal storage system may store expression objects and relationships among expression objects. (See FIG. 39, for example.)

The following combined operations may be possible in the expression, structuring and storage of objects: a simple new expression object, the expression of a relationship of two existing objects, a new expression object with a relationship to an old information object, and two new expression objects and their relationship.

The minimum relationship that is stored at expression may be the relationship with time. Precisely every expression object may be associated with its time stamp.

Expression Objects and Open Information Objects

According to various embodiments, information object may be that the expression object is exclusively the added value of a person to existing information. Concepts are associations of components recorded previously, (including other's knowledge). A document may be an open information object that contains a complete group of associations among open information objects. Therefore, an open information object links to objects built previously, and produces a graph of relationships among objects: expressing relations among previous expressions, and produces a graph.

The resulting object may be a new object that links (and uses) the old object and has a variation (or added value). The evolution of objects sometimes one wants to update previous notes like: expired and done.

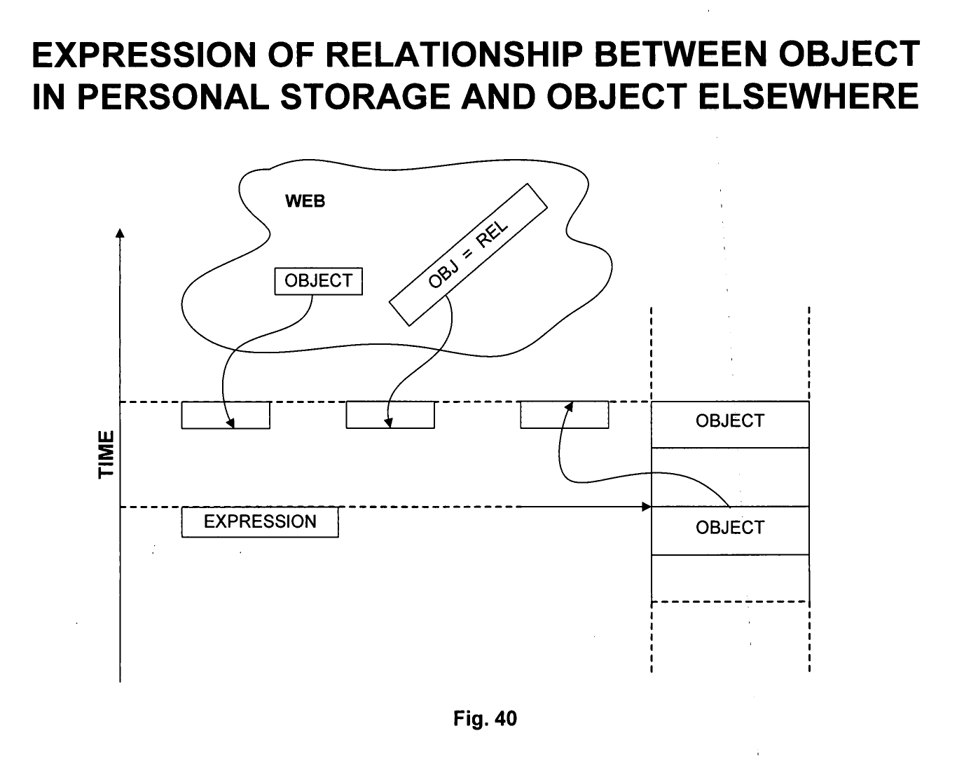

OIOs may be at various levels. An OIO's granularity may be as fine as a symbol or word. Alternatively an OIO can be a composition of OIOs of lesser level previously produced. FIG. 40 depicts a view of the personally owned objects including the linking to objects owned by others (in the web).

According to various embodiments, a method to create open information objects, may be provided that comprises capturing a personal expression of a person, selecting an existing expression object of said person, selecting an existing information object, wherein the selection is done by said person, defining a new information object as the set of address identifiers to said relational operator and said expression and information objects, assigning a time identifier to said new information object, wherein said time identifier is a moment in time between the earliest of the time identifiers of said expression objects and the moment in time of defining said expression, assigning a owner identifier of said expression object, wherein said owner is said person, creating a electronic address identifier to said expression object, and recording said expression object in electronic memory.

This method may also involve determining relevance of the components information objects (and added value), copying the existing objects into the new objects, access log, and access control.

Method to Define Open Information Object Access Control

Each OIO may have its own access control. The creator may decide at expression, or later, who has access to the OIO. Access control may be permanent and may be modified to a less restrictive access control, following the common sense of the information in the brain: when someone knows something, it is not possible to wipe it from her memory. However, changing the access control may be implemented through a new expression: thus producing a new OIO is whose only difference is the access control. The access control may be another expression.

An access control may take the form of any logical (Boolean) expression or people or software programs (OIOs). Examples include: no one has access (totally private), everyone has access (totally public), my family has access, John has access, my accounting program and my accountant have access, everyone in the world, but Susan has access, and my bank agent and my account aggregator web services have access.

In one exemplary embodiment, the expression object may not have the same types of concepts of write, read and execute, as in traditional operating systems. In this exemplary embodiment, if a creator gives access to an OIO, it means that others can use, but it will not be theirs: others can use it to produce a new OIO with the selected OIO as parent, or they can create a clone for memory efficiency purposes. In this embodiment, there is thus no such concept as “copying an open information object” by changing name, owner, timestamp etc. like in operating systems.

The OIO access control introduces a concept that is new in any information technology existed and models actual human brain activity. If a person decides not to express some information in the brain, she will not. In the same way, if a person has information in the extended brain with an access control equal only to self, then it must be enforced. In order to do that, laws to enforce these protocols and procedures may be put in place.

In continuing with this exemplary embodiment, access control to an OIO is distinct from object communication. If person A gives access of an object to person B only, then B may be prevented from giving access to the object to others, without A's changed permission. It is true that it is impossible to prevent, for instance, that information in the extended brain with access to B can't be transmitted face to face to person C. However, two issues must be considered. First, with extensive recording and time stamping, it is possible to track who communicated what. Second, in the information economy it is reasonable to assume that the portion of access control break-ins are minimal with respect to the total of transactions.

Technology infrastructure may not concern itself with impeding cheating, or it may. Good behaviors must be developed with education and law enforcement, not with technological force to minimize the ability of people to bypass these procedures.

Enforcement may by made through technology, but also, the methods and systems may incentivize good behavior, build enforceability by building laws, good practices, and education, attempt to limit the number of disputes to a smaller portion of the transactions, set up legal practices meeting the system in the real world, and/or set up the groundwork for reward tracking.

Accordingly, various embodiments may include the following concepts: personal expression: one individual only using only own expressions, personal expression and the web: one individual using expressions of others, collaborative expression: multiple individuals using own expressions, and world expression: multiple individuals using expressions of others.

Defining Components of a Child Open Information Object with Respect to Parent Open Information Objects

In this section various embodiments of the properties of new (child) OIOs with respect to parent OIOs may be discussed.

Creator: the creator of the OIO may be the expresser. However, in one view, because the creators of parent OIOs are contributing to the ultimate result of the OIO: they may be called contributors. In the relevance section, there is a discussion of the total contribution by each contributor.

Creation Time: the time stamp of the parent OIOs does not have influence on the expression. However, it is possible to calculate the time span of a complete OIO, by tracing the genealogic tree to the oldest relative OIO.

Identity (eternal): the identity of the OIO does not have to refer to the parent identity. However, the parent identity can be used in the algorithm to generate a child identity if there is potential conflict.

Access control: access control of an OIO is the intersection among the access control of the expression and any of the parents.

Novelty: the novel content or the expression can be the same or different as other OIOs. However, there may be no specification to determine a priori what to do if the there is overlap. These issues may be resolved based on the decision of all expressers.

Relevancies: The relevancies may be calculated in a scale (e.g., 0-1 or 0% to 100%). The sum of the relevancies needs to be the upper end of the scale (e.g., 1 or 100%). The relevancies may be attributed by the creator, but they could be also defined by other entities.

Access log: may be independent of the parents. However, the parents may be requested any time the OIO is requested.

These are examples of expression types: relationships (or links) among information objects, relevance of an information object as part of a composite information object, equivalence among two information objects, added value of information object with respect to another, access control of an information object, cause and/or effect relationship between two objects, likelihood of a cause-effect relationship being a fact, assumption, or conjecture, priority of object wit respect to another, and add/change/remove from a list previously created.

Building on Other's Content—Linking Versus Copying

When using existing OIOs to build new information, it is possible to use a whole OIO, or a part of it.

Link (refer or use the whole thing). The problem with the link is that in today's web people change URL: links break. In one embodiment, data is stored with a permanent address identifier.

Excerpt (copy a piece and paste or use). The problem with the excerpt is that if using a piece still needs to link to the whole object. This is acceptable for small objects, but for big objects, the eventual verification of relevance and value add may be postponed.

Transcribe (input something produced by others, but not recorded). The problem with transcription is that it is too susceptible to “cheating”, meaning that one may say it is hers.

Typically, when someone reads something and wants to reuse all or part of it, this is what happens: create a personal classification, so it is a new object, create a link, a title, date, author, abstract etc., a local copy, and a pointer to the local copy.

Collaborative Expression Object

The expression may be the product of collaborative work. These are the situations of collaborative production of expression and OIOs.
n×1: collaborative expression: multiple individuals using own expressions
n×n: world expression: multiple individuals using expressions of others

Memory Model Section

The memory model includes two main parts: the technological issues about open information objects and their electronic memorization, and the issues about the extended brain memory of a person.

Memory System for Open Information Objects

The components in the memory model include the following.

Open Information Object (OIO). The properties and components of an OIO so that they can be electronically: created, stored, searched, transmitted, retrieved, and interpreted

OIO handler. Technology on electronic devices in order to: catalog, memorize, search, retrieve, and transmit OIOs.

Collection of OIOs. OIOs do not have to be memorized in the same device to be grouped. We introduce the concept of the OIO collection, where individual OIOs can be memorized anywhere in a virtual storage. For instance, the extended brain memory of a person is a collection of OIOs; it is possible to consider the options of memorization of such a collection: concentrated in one electronic device, for instance a memory implant in the person itself, and distributed in multiple electronic devices.

Files have been traditionally collected in a PC, or a directory, or a certain file system storage, and there has never been a logical virtual storage system for a person. Examples of collections of OIO: the extended brain memory of a person, or all OIO of a person, all objects created on a certain day, and all text files of a person.

Memory Related Open Information Object Components

The Open Information Object may have the following components related to storage on electronic devices: object type, media type, object size, storage log, and input sensor location in space.

These components may be in addition to the components defined in the data model.

Object type: new, clone, link.

Media type: text, sound, image, video, etc.

Object size: electronically, the number of bits or bytes

Memory log: the log of the identity of the devices and the memory address on such device where the OIO is stored over time.

Input sensor location in space: location (GPS) to select among multiple simultaneous inputs.

Open Information Object Daemons

Open Information Objects may be created and memorized on different devices. Daemons may be used to create, store, search, transmit, retrieve and interpret an OIO.

Creation Daemon.

The creation daemon may be the module that allows the OIO to be packaged with the components. These are the tasks of the creation daemon: assign OIO components and properties as requested by creator, assign OIO identity, and deliver OIO to memory device.

Storage Daemon.

The storage daemon may run on the electronic device where OIOs are memorized, and on the device where the object is delivered. These are the tasks of the storage daemon: keeping a table of the OIOs stored by OIO identifier and correspondent memory address (or URL), updating the table if the memory address is changed, and performing reverse lookups to find objects with a certain identifier.

Open Information Object Views

Object view. A person may be an OIO, and the object view may be what that person views: identity (who am I?), creator (who created me?), location (where, or on which storage device am I), parents (what other objects do I relate to?), and components and properties.

Collection view. A collection of OIOs, and what that collection can see: properties of the collection, OIOs in the collection, identifiers of the OIOs, location of the OIOs

Storage device view. What the storage device can view: for each OIO in storage: identifier of the OIO, and memory address of the OIO.

Generating a Unique Permanent Object Identifier

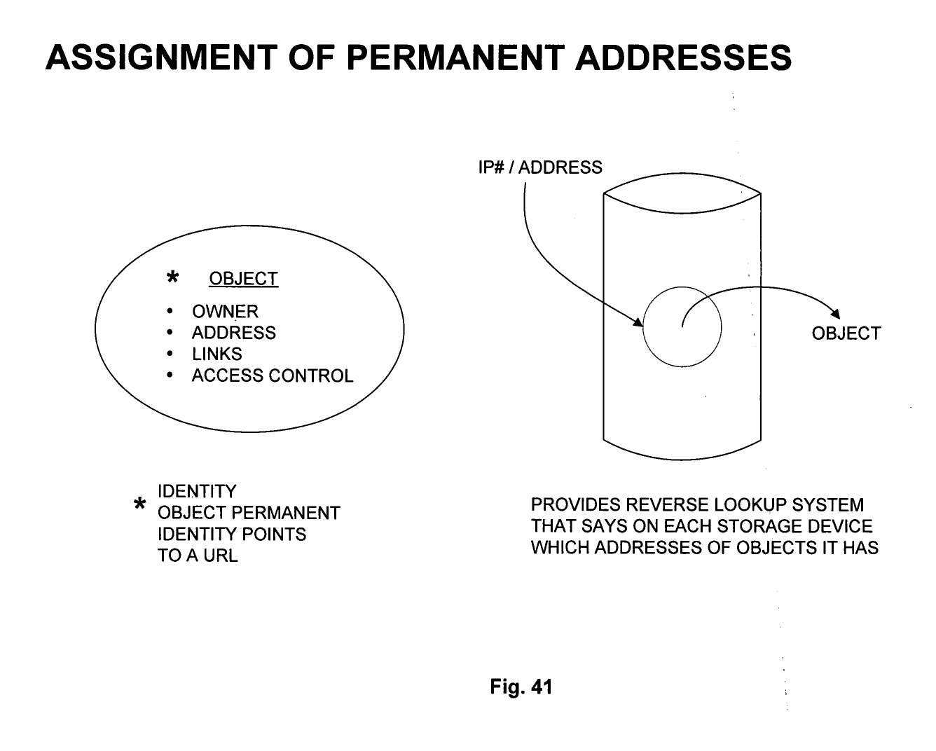

A unique permanent object identifier may be created by using the object properties of the data model and storage model, see e.g., FIG. 41. The unique permanent object identifier may be generated by encoding any of the following components in order: creator, creation time, input sensor location in space (GPS), object type: new, clone, link or mixed, media type (text, sound, . . . ), object size (electronically: number of bits or bytes), novelty, links to other objects, and access control.

Extended Brain Memory—Personal Lifetime Memory System

In this section, exemplary embodiments may be described for a system for storing a lifetime of expression objects of a single person. These embodiments follow the storage model of the brain and may be used as an extension of the human brain's memory. The personal memory system is referred to a single person or creator. The extended brain memory is the collection of expression objects owned by the expresser and may have one or more of the following attributes. Starts at birth. The storage system is created at birth of the expresser. Seals at death. The storage system is completed and sealed at death of the expresser. Ownership: the memory has an owner, which is the creator of the expression objects. The creator (owner) can not be changed. Contains expression objects from the creator only (preferably, but not necessarily). The creator is the only one who decides what is included and what is not. Chronology: it is not specified how the expression objects are physically memorized in electronic form. All it matters is that an object memorized with a time stamp, an eternal address and a creator allows the whole creator's memory to be recreated, and chronologically sorted if desired.

What can be memorized in a person's extended memory: only creator's created objects, no object expressed by others, but pointers to them, if expressed by said person, and clones only for the purpose of caching (addressed specifically).

Various embodiments then provide a system to electronically memorize personal expression, that may comprise: an identifier to a person, a time scale, wherein the time scale starts at birth and ends at death of said person, a pointer from a time value in said time scale, to an expression object, wherein said expression object has said person as the creator identifier and said time value as time identifier, and a system to lookup the identifier and access said expression.

The system may also provide the following features: options of expression objects, starts at birth, seals at death, and centralizes (one physical) or distributes (virtual, with pointers) storage.

Extended Brain Will—Information Beneficiary

A person's lifetime memory system may enable (and in some embodiments require) that a will and beneficiaries be defined. In one embodiment, the beneficiary may be the same as in the real world.

Possible changes of access control to expression objects at death may include: Expression objects not assigned in life. Expression objects not to be assigned: equivalent to secrets that die with person. Expression objects to be assigned at death: equivalent to secrets in a will. Expression objects that were assigned an access control in life preserve the rights after death: i.e. the rights can not be made more restrictive, as during life. However, the person may decide whether, after death, to assign to the beneficiaries the private expression objects, i.e. the ones whose access control was only the expresser itself.

The beneficiaries may or may not extend the access control of expression objects of their relative upon their own death. One option is to make expression objects public domain after a selected time.

Personal Storage Efficiency

This section describes an exemplary software architecture that implements the concepts and values of the extended brain, while using existing components of information technology, in order to make the implementation more efficient. Other technological issues in storage that may improve performance may involve: cached relationships structure for “frequent” lookups, cached copies for avoiding broken links and efficient lookup, and handling of collaborative expression.

Storage Segmentation

Problems of aggregating and storing information objects include: efficiency in upload, search and retrieval, user determination of access control, and copyright violations.

A virtual storage can be segmented in multiple ways, and at least with respect to these classifiers: media type, object size, ownership, access control, and object type.

In addition, it can be segmented by any other of the properties of the OIOs listed in the data model and storage model section.

Charging Segmented Storage

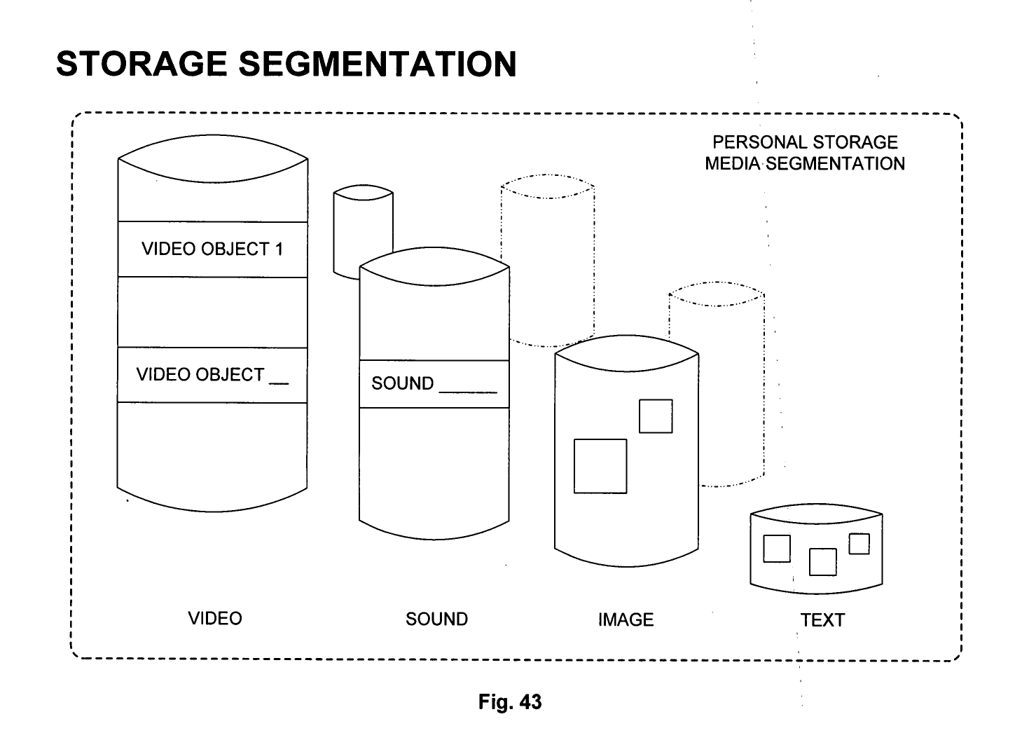

The segmentation of storage may be used to charge different rates for different segments (see FIG. 43). These are examples of useful pricing for segmentation.

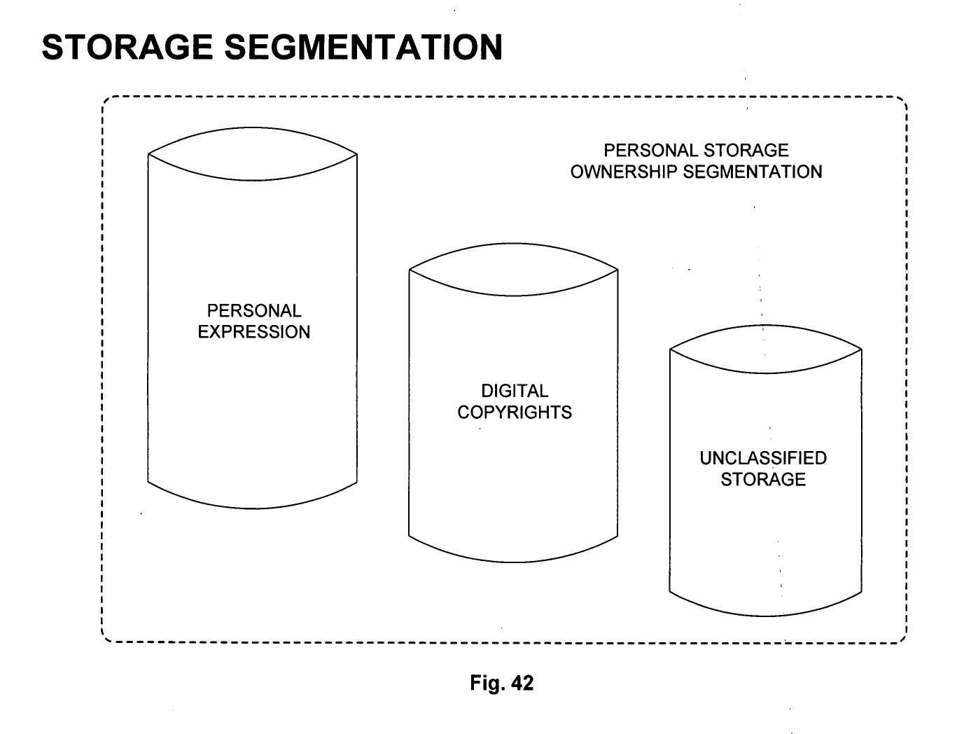

Segmentation by ownership (See FIG. 42)
a—data user owns in the sense that are a personal expression
b—non-commercial data of others (with access right)
c—commercial data user has a legal copyright
d—data of unknown rights

Owned information is cheaper: this encourages linking instead of copying.

Segmentation by media, i.e. storage segment that only allows:

| | | |
|---|---|---|
| Text | most expensive | example: $20/GB/month |
| Sound | mid expensive | example: $ 3/GB/month |
| Bitmap | mid expensive | example: $ 5/GB/month |
| Video | less expensive | example: $ 1/GB/month |
| Links | free to other's extended memory | |
| Clones | very cheap | |

Other segmentations: it would be possible to make segments for whatever selected file format (e.g. MS Word, Adobe PDF), and leave a segment for anything not comprised in the selected file formats.

The pricing structure may be decided to be higher (per byte) for lighter formats (like text) and lower per heavier formats. However, because files with heavier formats require a higher order of storage, then there would be an intuitive tradeoff.

This exemplary price structure incentivizes people to store data in the right file segment. For instance, if one were to place a song in the text segment, it would fill it up with one song. Or if one were to place a text file in the video segment, it would take slower to access it.

If files of the improper file format are stored in a storage segment, these are the possible consequences: (naturally or artificially) run with less efficiency (slower access), and checked for file format and aborted.

Segmentation by Access Control:
encrypted versus not (cheaper)
private (cheaper)
groups
public (unencrypted)

Storing a Copy Versus Linking

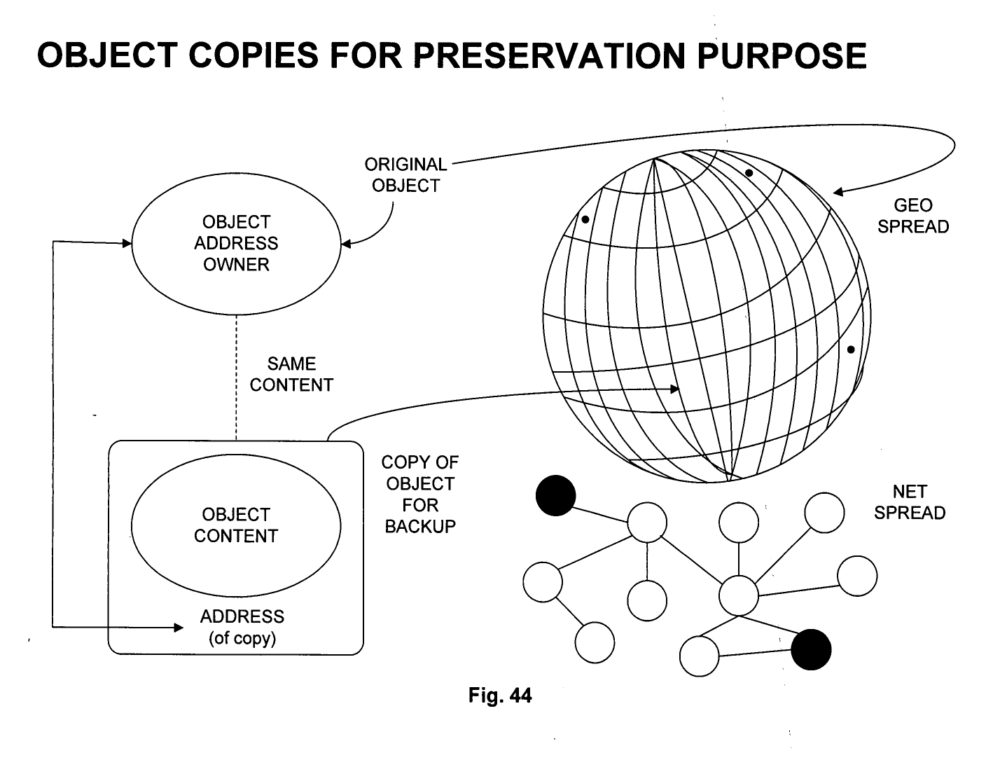

Copies of information are important for preservation and efficiency purposes. However, the extended brain data model favors innovative expression, while avoiding unnecessary replication of data. The copies made for preservation or efficiency may be on a: geographical spread, logical network spread, hardware spread, and any other replication to prevent possible faults (see FIG. 44).

Personal Extended Memory Location

The place of and manner of storage at the personal extended memory location may vary with many options and issues. Preservation. The way to decrease the risk of electronic information loss is to create multiple backups. Backups shall also be geographically dispersed. On the other hand there is the problem of media update, meaning that if the recording media becomes obsolete, the storage needs to be updated on the new technology. Physical location The ideal place for the main storage would be with the person itself. Storing in a PDA or PC outside of the body is not optimal because it can be separated from the person (voluntarily or accidentally). Therefore, a storage implant would guarantee that the “live” storage is with the person, while the backups are geographically dispersed. Another method would be for synchronization between devices associated with the person.

User Interface Model Section

This section involves a discussion of various embodiments for a method for a person to: create expression, search information objects, access information objects, and display information objects.

In the current IT model based on applications the following is confused and convoluted: user input, display of information, and operations on information.

It is not clear and unequivocal to a person what is her contribution with respect to existing information, and whether the intention is executed.

One purpose of the user interface model embodiments describes herein is to: distinguish the user input from the information being accessed and displayed, capture the input, and relate the input to the intended information.

User Interface Modes

Application mode. The term “application mode” may be understood to relate to an IT environment whereby a user selects a software application that contains a set of tools that can only be applied if a file is opened with such application. The application mode is “process centric”: it focuses on the processes to input a file, operate on it and produce a resulting file.

Digital canvas mode. The term “digital canvas mode” may be understood to relate to an IT environment whereby a user expresses information, and selects from a toolbox of operators on such information. The digital canvas mode may be “data centric”: it may focus on the data and its evolution, by allowing to separate data from operations and to apply any operation that may be available.

The digital canvas enables “data flow”: data evolves eternally digitally to-from human brain, operations on data are searched, and new data is produced building on existing data.

A digital canvas mode also enables process flow, because processes are also data. A process is formerly defined data, and it is applicable to other data. A toolbox for the digital canvas could be a subset of operators from full featured apps, like: paint brush, text editing, page layout, copy, cut, paste, basic picture manipulation. In the application mode, most applications need to provide for cut, past, rendering etc.

Also available to the digital canvas mode may include project specific templates, which help users in tasks such as: writing a letter and making spreadsheets.

In order to enable the transfer of the features in the existing applications into the digital canvas mode, a set of interfaces and transformations may be provided so that features can act upon any type of data.

Mixed mode. Once the relationship between the application and the digital canvas is expressed, then it is possible to have a user interface environment that set a preferred digital canvas embodiment, or an application, or any combination of the two (arbitrary fixed point).

In one embodiment, the applications provide interfaces so that a user in the digital canvas mode could rent and call application functions to perform operations on the data. This is where digital canvas meets “Web services”.

Digital Canvas and Free Input

The digital canvas may be the free input environment of a person. The digital canvas may be: infinite in space, and eternal in time.

Infinity in space includes that the composition (such as handwriting or typing) should not have a “page” restriction. Electronic media does not need to impose such limitation, unless one wants to.

The “page” is just a view that shall be discretionary, or proposed for output purposes, such as printing.

Free input can happen in the form of: handwriting, typing, speaking, and any other form of user action capture.

These are a list of possible expression objects from a user: user actions (input), expressions, actions in applications, and files.

These are possible environments where the personal expression is memorized: any electronic device memory, PC hard drive, server file system, and web space.

Canvas includes time and space in multiple dimensions: space (video), time (voice), space and time (video+voice), and the canvas may have multiple input sensors.

Digital Canvas and Display

The current applications provide views of the data, and request users to input data in the format of the views. Input and output are totally confused in the current information technology model: this is very restricting and inefficient. The current applications provide views that can be used in digital canvas mode.

While the digital canvas may be the environment where user input occurs, information may be displayed that is directly or indirectly related to the input. It is possible therefore to distinguish: what is input by the user, what is accessed and/or perceived, and what is the relationship among the previous two.

Factors that may determine different relationship between input and display may include: is the user expressing or requesting (command)? does the user have simultaneous access and display to the expression, or not? does the user have access to existing information (while expressing), or not?

Simple input includes: user expresses, user does not have simultaneous access and display to the expression, and user does not have access to existing information. Example: a user speaking to a voice recorder.

Input while viewing: user expresses, user has simultaneous access and display to the expression, and user does not have access to existing information. Example: a text editor.

Simple communication includes: user expresses, user does not have simultaneous access and display to the expression, and user has access to existing information. Example: the text box of Instant Messenger.

Communication while viewing includes: user expresses, user has simultaneous access and display to the expression, and user does have access to existing information. Example: the text box of Instant Messenger.

Simple command includes: user requests and user does not have simultaneous access and display to the expression. Example: voice activated telephone menus.

Command line includes: user requests and user has simultaneous access and display to the expression. Example: Operating System command line prompt.

GUI input may involve: multiple iterative expression and display of own and other's information.

GUI command may involve: multiple iterative expression, command and display of own and other's information.

Digital Canvas Mode to Data and Memory Model

This section describes one exemplary embodiment for how a user may be enabled to function in digital canvas mode.

Actions may include: communicate expression, defining an object, and relating objects.

This includes: search object (including operator/tool), request and access object, and display object (including operator/tool).

Object is then: coded in data model and stored in memory model.

Digital canvas mode: the user enters whatever whenever wherever, user information is defined and memorized, user borrows commands to apply to the data, and need control of the OS.

Application Mode to Data and Memory Model

This section describes an exemplary embodiment of how a user may be enabled to function in application model.

Application mode: the user opens an application and uses as normal today, all information input is transformed into OIOs, all operations applied to data and user actions are transformed into OIOs, and changes to existing information is transformed into OIOs with a link to the original information and the variation. Example: the user works in an application, like MS Outlook, the user creates a new mail (by clicking “reply”): this triggers an object that is the action of the user creating a new mail, there is existing data in the email (the sender's email), the user writes a new expression: this expression is related to the object that was the sender's email, and the user selects a recipient: the recipient is related to the expression the user puts in the body of the email.

In summary, the structure of the Outlook email app is used to create and save (in the OIO data model) the relationships among the user information and action.

Mixed Mode and Switching Between Digital Canvas and Application

In another exemplary embodiment, the user is enabled to switch between these modes and vice versa. The mixed mode may comprise one or more of the following: digital canvas and application modes live, actions in one mode are translated and displayed in the other mode, and switching from one mode to another is seamless.

Method to Transform User Actions in Application Mode into the Digital Canvas and Data Model

In this application model a user may: open an application, work on the file, and save the file in that format.

Interaction possibilities may include: get real, get closed, feed real, and feed closed; or: extracting information from a file in closed format (a saved file), extracting input information from an app in real time, feeding batch information to application (into closed format), and feeding information in real time into an open application.

Digital Canvas Toolbox

In the digital canvas mode the operators on data may be in one or multiple toolboxes, and are requested, searched, accessed, like any other OIO. The operators may then be applied to the desired OIOs.

Digital Canvas Layers

Relationship of the digital canvas to existing information: digital canvas layers, and assignment of relationships between what is input and existing (viewed) information.

Digital canvas layers may include: view, input, suggestion, confirmation, and code.

Access layer: may be the collection of the OIOs that are accessed and perceived by the user.

Input layer: may be the layer that contains the expression.

The input layer may be the “command line” of the computers.

The input may: appear in the view layer (but it does not have to, like it is normal in speech), and be related to the access layer.

Suggestion layer: computing may perform some calculations on the user input, such as: text recognition (for handwriting or speech), spell checking, and grammar checking.

The suggested information may be kept in relation to the original OIO and available at all times.

Confirmation layer: the confirmation layer may be the OIO that are subsequent to the final review and acceptance from the suggestion layer.

Code layer: the code layer may be the information as it is programmed into data model.

### EXAMPLE

### Digital Canvas Input with the Tablet PC

In this example, the digital canvas may be infinite in space, the user searches for a previously written document, the user lays it out so that he/she can scroll up and down from beginning to end, the user can select at any time any subset of it, the user can handwrite some lines to indicate relationships between viewed text, the user's handwriting is an expression object that relates two previously defined objects, the user's expression is saved as an OIO and related to the OIOs of the accessed and viewed text, meanwhile, the computer has performed text recognition of said handwriting, the suggested text is an OIO and is related to the expression OIO, the user can switch from the handwriting to the text recognized layer to see what the text was, and the user can make a change to the text and save the confirmed text as an OIO confirmed.

The handwriting, suggested text, and confirmed text will always be available, by switching to the corresponding layer.

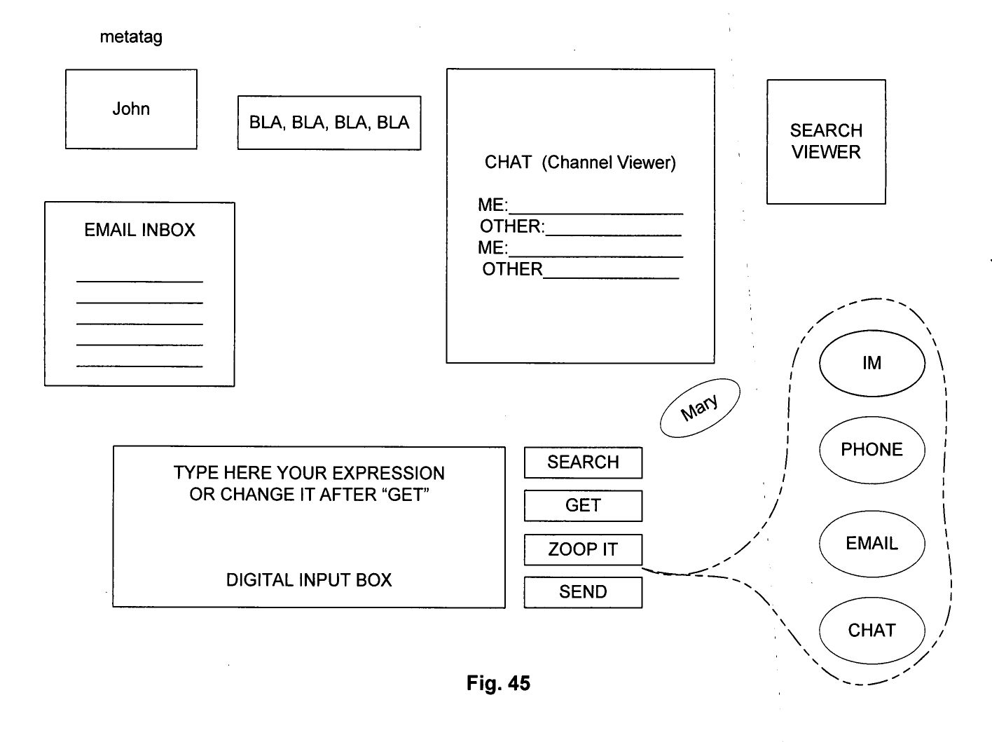

FIG. 45 depicts one exemplary embodiment of a digital camera.

Interaction Between UI, Storage and Data

Searching the Personal Storage

The process of free expression input, storage and structuring described above follows the model of how the human brain develops and stores information relationships. Searching information in the extended brain memory, following the model of how the brain searches for information.

Fetching the Personal Storage

By reproducing the model of information input, memory and structuring of our brain, we can use the incredibly powerful capability of computers to: store information (and relationships), and allow searching so to have an enhanced information space and thinking capability. IT information searching is already incredibly powerful: what is missing is that information is not organized by humans at the source, meaning as close to its production.

Viewing information may be separate from information input, and organization. Viewing may be consequent to the request of searching. Input from output may be separated: in the current applications there is confusion of input and output.

Errors may be handled naturally with a new expression.

Structuring Pre-OIO Information into the Extended Brain Memory

The discussion on expression explains how to do “forward input”, i.e. input new stuff in the future.

The information produced in the past can be transformed into the OIO data model (“backward input”). This includes reorganizing existing documents or any personal information sources (paper+digital+brain) used in the lifetime. This can be done with a dialectic process to structure data.

Backward input:

Order 1: metatagging the file may involve the following tasks: search for files, search the filename, verify if there is a title of the file, determine the tag of the file, and metatag the content of a file with its filename.

Order 2: metatagging and transforming into OIO the content of the file.

Order 3: developing relationships among files that were not entered at the time of expression because of the inflexibility of technology.

Prospective Input Form

In this section, an exemplary embodiment is provided that provides information to forms as a dialog, to reuse information and request only necessary and agreed upon information between the parties. The prospective input form provides an example of one solution according to the present inventions to address the frustrating experience of all of us today when filling out forms, both printed and on the web.

Forms may have: more fields than the user has information to fill (optional), mandatory fields, for which the user does not have information yet, and fields relating to information that has been previously filled out elsewhere.

This results in the following problems that we all know.

Unnecessary work repetition: if one does not have available a mandatory value, will need to start from scratch after the value has been found, same if there is a failure in technology, password or whatever, and printed forms require to reenter everything at least twice.

Errors: reentering data increases the error rate, and print forms have even more error rate.

In this exemplary input form embodiment, the user: provides her extended brain (soup), the form supplies a list of mandatory fields, the form requests the values for all the mandatory fields from the soup, the soup provides the requested fields, if there are ambiguous fields, it requests verification of equivalence of fields in order to fetch the values, if there exist missing fields in the soup, it requests the values for the fields (which go in the soup), and then to the form requester, the form requests the user if she wants to turn in optional fields or not, if the user wants, than the optional fields are supplied to the user soup, the user decides what fields to supply information for, and same steps on selected fields as on the mandatory ones

Therefore, the steps to input information on the two sides of the business are separated: the requester (form), and the provider (client).

This exemplary forms embodiment creates a flow where only necessary information is transmitted. Information is also collected and structured in a way that it can be later reused.

Other elements include: collect and structure data, collection (somewhere) of any information for later reuse, store in a place to be later found, and request additional information.

One example of how this exemplary form embodiment may be used involves the concept of a “Prospective Account”. The prospective account has two sides. On one side, there is an account requestor and potential holder. The requestor prepares some information requested in order to create an account, and requests to the account leader or administrator the creation of an account.

On the other side, there is an account administrator who enters options that will be available when the account is created, and specifies the information that is necessary for the account to be created.

When the transaction is completed, then the account is created and the previously entered features are acquired. There is a match and negotiation of the information entered on the two sides, following the steps provided in the general description of the exemplary form embodiment.

Application User Interfaces & Programming API

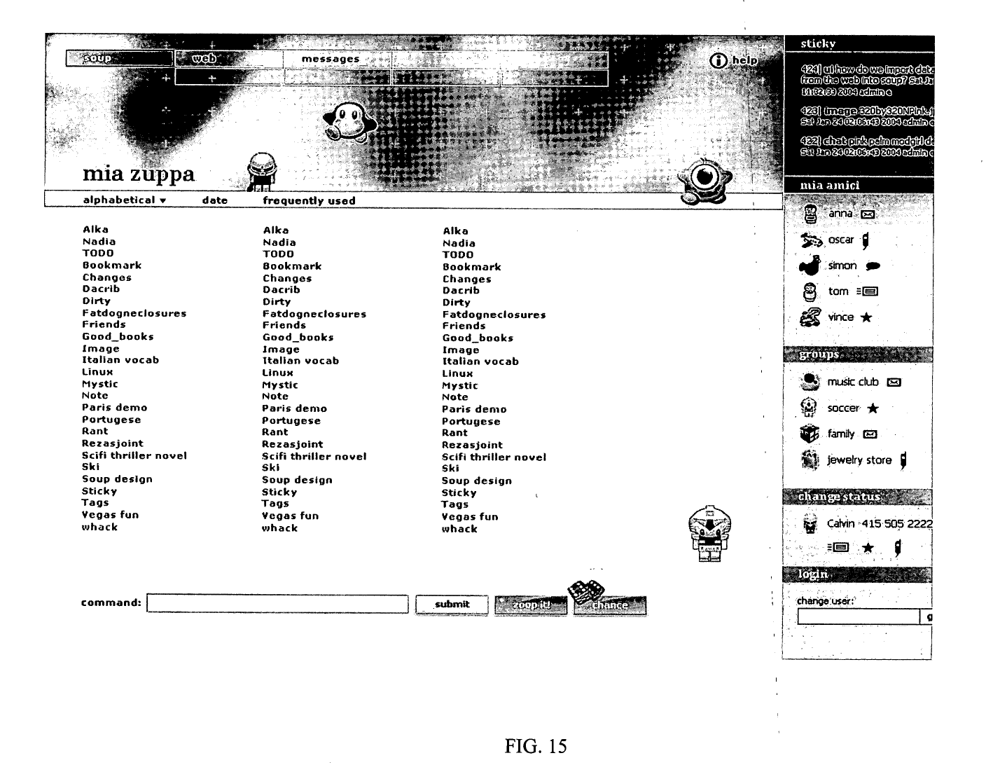

As discussed above, an application may be provided that offers a place where a user stores all the information. Just like the brain stores concepts, this exemplary embodiment of an application may provide a central place for all types of information, including everything from email, picture, music file, document or a single sentence or tidbits of information. These kinds of information and more may be related to the same set of main classifiers or tags. FIG. 15 shows a WWW (world wide web) interface embodiment. In this embodiment, the application makes it very simple to relate or share information from the extended brain to people or groups of people. This capability is represented by the lists of people to right of the main classifier space.

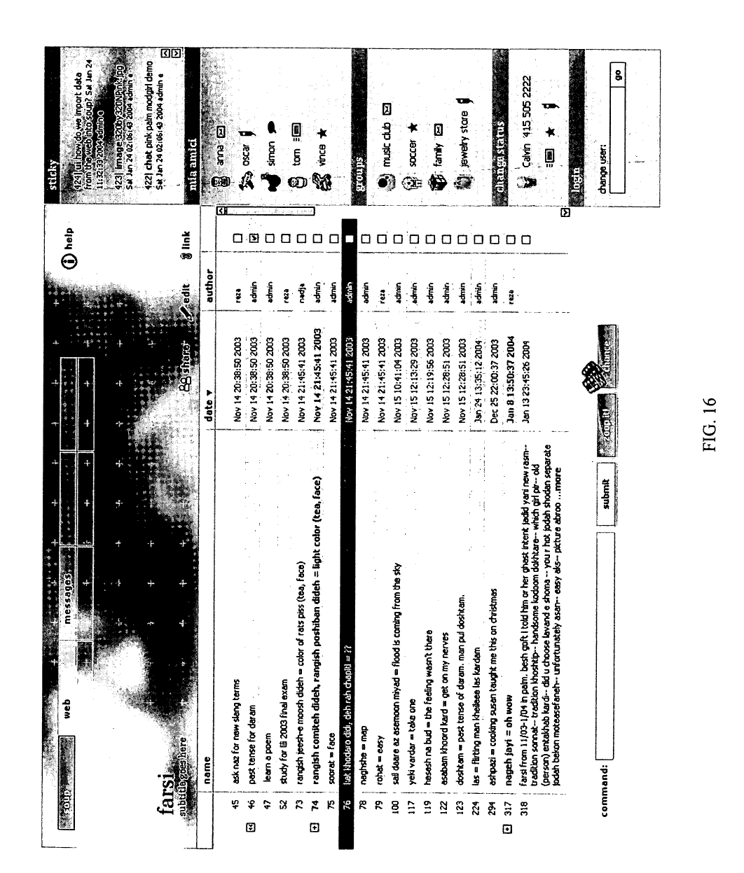

FIG. 16 illustrates an exemplary embodiment of what the application may present if viewing the contents of a classifier or tag, elsewhere in this document described as an OIO. In this example, there are many piece of information related to the main classifier, tag or OIO, entitled ‘FARSI’. This is a novel approach to storing information because it lets the user relate many concepts or types of information to a single concept. For example, in the current models of computing, if a user wants to create a TO DO item, CONTACT or write a paragraph of information, or save a single sentence of information, they would be forced to use several independent applications. TO DO and CONTACTs may be managed by a Personal Information Manager program, a paragraph of information would be written in a word processor and saved as a file object, and a single sentence could be sent to one's self as an email, stuck inside a word processor document, or placed in a sticky note application. None of these methods are very reliable, they are completely disaggregated, making information retrieval (how do I find it) and reuse next to impossible. The extended brain application embodiments of the present invention may allow users to relate any type of information, OIO's, or Personal Expression objects to each other. This simplifies information management because all data convenient related and retrievable.

Command Line Version of the Extended Brain

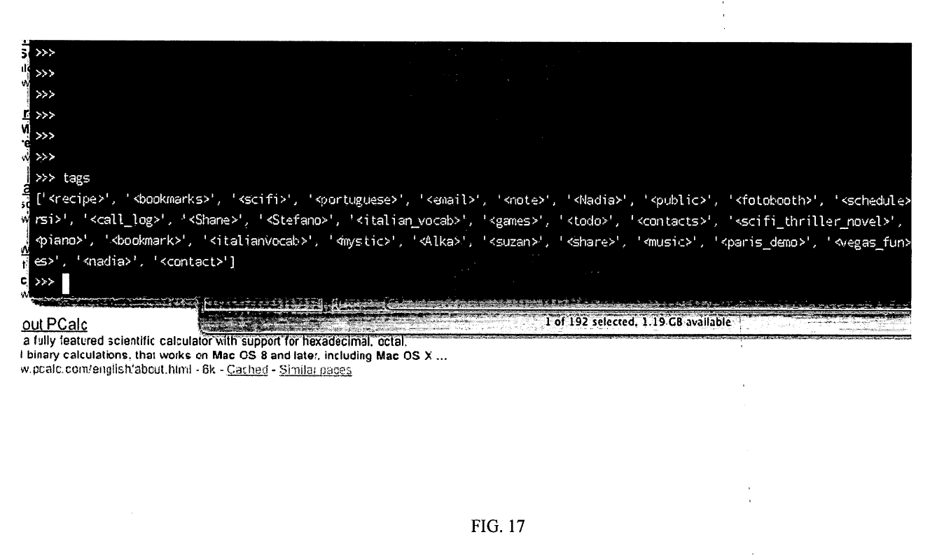

In one embodiment, the application may be built as a text-based command-line styled application. In FIG. 17, an example of a method to express OIO's, classifiers, and tags using a command line is depicted. Different topics may be related to new OIO's and Personal Expression Objects. OIO classifiers in this example span many types of Personal Expression ranging from pictures, to do lists, or vertical topic areas to store all the information about your friend Stefano.

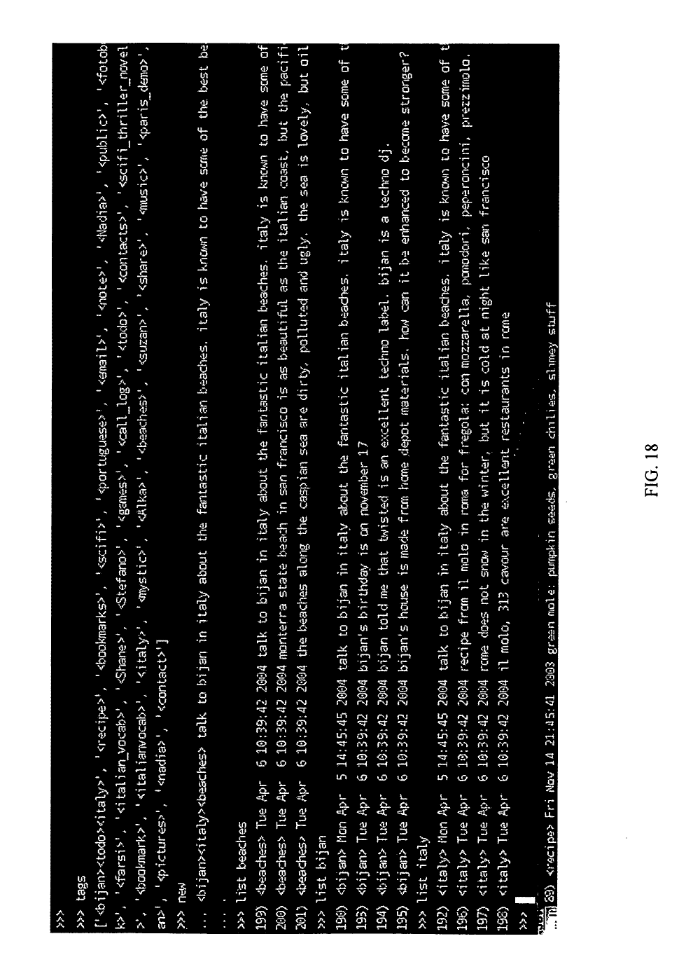

FIG. 18 demonstrates an exemplary method of relating multiple OIO's and classifiers to one specific OIO or piece of information. After the ‘New’Command, the user may be presented with several OIO's, here specifically, ‘<bijan><italy><beaches>’ and the main OIO, “talk to bijan in italy about the fantastic Italian beaches. Italy is known to have some of the best beaches in the world.”. In this example, the method for relating the main OIO to several independent are presented as being linked OIO's. When using the LIST command, the user may see the contents or relations of OIO's to specific OIO classifiers. In other words, the user may see the ‘talk to bijan . . . .” OIO related to <beaches>, then <bijan>, then <italy>.

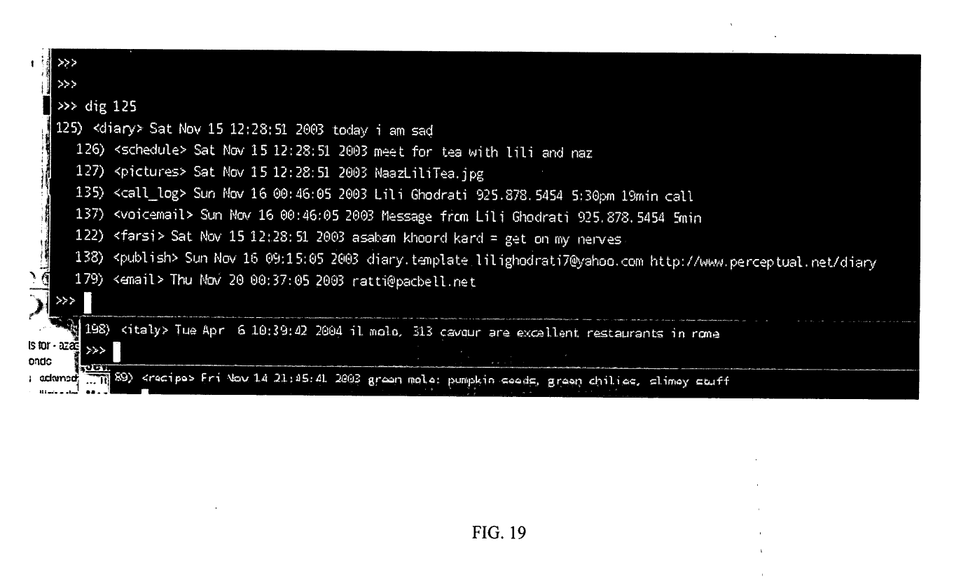

FIG. 19 is another example of the methods for relating a diversity of Personal Expression Objects to OIO's. Here you see the <diary> OIO or classifier. Related to the <diary> OIO you see schedule OIO's, pictures, voicemails, farsi, etc.

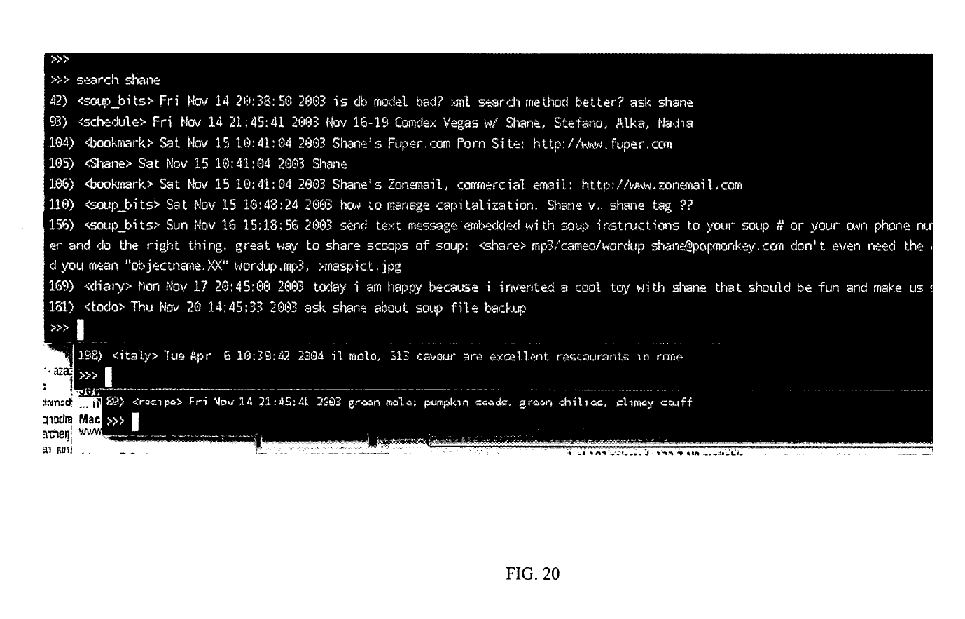

FIG. 20 demonstrates the incredible flexibility, of the Extended Brain and OIO model. In this example, you see the output of the SEARCH command. Here, the user may find OIO's or classifiers with the content ‘Shane’. In the OIO model, it is easy to find any type of Personal Expression because they are stored in open formats and can be related to one another.

In addition to these examples, an exemplary source code appendix A is submitted herewith that provides but one example of source code that may be created to provide various embodiments of the present invention(s). This example should not be construed to be limiting. Indeed, none of the examples provided herein are intended to limit the inventions described.

Further, although the embodiments of the present inventions have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein.

### Appendix A

Example Listing of Possible Commands for the Command Line Embodiment

| Command | Explanation |
|---|---|
| new | <create a new OIO entry> |
| remove | <delete a OIO entry and all of it's children> |
| | example: |
| | <shane, we need an ‘r u sure’ error message> |
| tags | <lists all tags/OIO in your soup> |
| list <tag name> | lists the contents or chunks of the requested tag. example: “list |
| | todo” may displays chunks under todo tag |
| search ‘anything’ | searches for specified word in your extended brain. Example: |
| | search wedding, example: search todo, example: search bijan, |
| | example: search mp3, use search to search for your friends, stuff |
| | you did or content from research that you are working on. Search |
| | is very powerful because you can find all your data and the |
| | relationship to it with your other work very easily. |
| link childtag# parent tag# | link allows you to link a chunk stored in one tag to another tag- |
| | chunk pair. example: link 18 87 [link chunk item 18 to chunk |
| | parent 87] why link? suppose you want to create a “party” tag |
| | for all information relevant to the party you are planning. you |
| | will want contacts, pictures ideas, all to be linked to your “party” |
| | tag. 18 <contacts> Shannon Elizabeth 415.505.6969 |
| | shannon@nice.org 44 <pictures> ibizapoolparty.jpg the ibiza |
| | party last year cause so much trouble! 46<pictures> |
| | lilyweddingkiss.jpg lily's parents thought this was her first kiss! |
| | 68<party ideas> make jello flaming jello shots. is it possible? |
| | 151 bacardi on top. 71 <lighting> make votive candle holders |
| | from pop cans. poke holes in the can. okay, now link all of these |
| | to a new tag called, <party>, which is tag 101. link 18 101; link |
| | 44 101; link 46 101; link 68 101; link 7l 101 |
| dig parent tag# | list all children of a tag. example: dig 101. 101 <party> 18 |
| | <contacts> Shannon Elizabeth 415.505.6969 |
| | shannon@nice.org; 44<pictures> ibizapoolparty.jpg the ibiza |
| | party last year cause so much trouble! 46<pictures> |
| | lilyweddingkiss.jpg lily's parents thought this was her first kiss! |
| | 68<party ideas> make jello flaming jello shots. is it possible? |
| | 151 bacardi on top. 71<lighting> make votive candle holders |
| | from pop cans. poke holes in the can |
| unlink childID# | removes the link between child tag and parent tag. example: |
| parentlD# | unlink 18 101 breaks link between 18 and 101 (removes |
| | shannon from the party!) |
| last | displays a log of the last soup commands executed in |
| | chronological order. |
| count | displays the total number of chunks in your soup. |
| save | saves last soup entries into your permanent soup file |
| quit | quit the program |

### Appendix B

Exemplary Application Programming Interface for One Application Embodiment

This pseudo-code represents the method and the basic set of API's and programming functions for programming an Extended Brain application with OIO's.

“““Convience class for unique integer generator”””
class Sequence:
def seq(self)
“““Chunk:”””
class Chunk:
def_init_(self, id, anchor, data, chunk_time=time.time( ))
“““Contains Chunks divided into namespaces”””
class Soup(Sequence):
“““Deleted chunk namespace”””
LABEL_TRASH=“<_trash>”
“““Active chunk namespace”””
LABEL_ACTIVE=“<_active>”
“““Prior version chunk namespace”””
LABEL_RCS=“<_rcs>”
“““Group namespace (for sharing ACL)”””
LABEL_GROUP=“<_group>”
“““mix: Mix a chunk with kids as direct 1^{st} generation decendents into the ACTIVE namespace”””
def mix(self, parent, *kids):
“““link: Create a new relationship between source and dest in the ACTIVE namespace”””
def link(self, source, dest):
“““count: Returns the number of chunks in the ACTIVE namespace”””
def count(self, tag=””):
“““slurpAll: Return all chunks from the ACTIVE namespace”””
def slurpAll(self):
“““slurp: Slurp all matching tags from the ACTIVE namespace”””
def slurp(self, tag):
“““slurpId: Slurp a chunk by it's ID from the ACTIVE namespace”””
def slurpId(self, sid)
“““hasChildren: Returns child count of given chunk ID”””
def hasChildren(self, sid):
“““slurpRelated: Return related (children of) Chunks of sid”””
def slurpRelated(self, sid)
“““tags: Return all tagnames from all namespaces”””
def tags(self):
“““last: Returns last count chunks entered into the ACTIVE namespace”””
def last(self, count=10):
“““remove: Migrates chunks with ID into the TRASH namespace”””
def remove(self, id)
“““slurpRCS: Fetch all prior versions of a chunk”””
def slurpRCS(self, id):
“““update: Update an existing chunk. Copies old chunk to RCS namespace”””
def update(self, chunk):
“““newerThan: Return any chunk from active soup thats newer than seconds”””
def newerThen(self, seconds)
“““hasChildren: Returns child count of given chunk ID”””
def hasChildren(self, sid):
“““unlink: Unlink relationship between two tags”””
def unlink(self, source, dest):
“““hasChanged: Have we change such that we require saving?”””
def hasChanged(self):
XXX Potential additional elements XXX
“““Determines if a specified user is a member of the specified group”””
def userInGroup(self, group, user):
“““See if an id is in the specified group”””
def groupIn(self, group, id):
“““Add the ID to the specified group in the GROUP namespace”””
def groupShare(self, group, id):

1. A method of electronically managing expression comprising:
receiving an expression object, the expression object comprising a data expression being determined by a creator and based on a creator-defined structure, the data expression and the structure being definable by the creator independent of any predefined structure of a software application; and
transmitting the expression object for storage at a data storage system.

2. The method of claim 1 wherein the expression object comprises a portion of a file.

3. The method of claim 1 wherein the expression object comprises a structure that is not dictated by any application in which data expression occurs.

4. The method of claim wherein the expression object comprises a subset of a structure dictated by an application in which data expression occurs.

5. The method of claim 1 wherein the expression object comprises a time identifier indicating a time between the beginning and the end time of said expression.

6. The method of claim 1 wherein the expression object comprises a data expression between a beginning and an end time that are determined by the creator.

7. The method of claim 1 wherein the expression object comprises a creator identifier.

8. The method of claim 1 further comprising the act of assigning the expression object an electronic address identifier.

9. The method of claim 1 further comprising the act of receiving input from the creator to define relationships relative to a plurality of data expressions.

10. The method of claim 8 wherein the relationships are defined using categories for one or more portions of the data expression.

11. The method of claim 8 wherein the relationships are defined using tags associated with one or more portions of the data expression.

12. The method of claim 8 wherein the relationships are defined using links between one or more data expressions.

13. The method of claim 8 wherein the relationship is based on a creator-defined structure.

14. The method of claim 1 further comprising electronically capturing data expression associated with a creator to the expression object.

15. The method of claim 1 further comprising:
capturing activity on a device in chronological order; and
using the chronological ordered capture to capture expression into an expression object.

16. The method of claim 1 wherein a creator may be creating multiple expressions at the same time.

17. The method of claim 1 wherein the creator may incorporate expression objects into other expression objects being created.

18. The method of claim 1 wherein the data expression occurs on a first creator device and is transmitted for immediate relay and upload to at least one other creator device.

19. The method of claim 1 wherein the data expression is captured through a default user interface without having to open a specific application prior to expression.

20. A method of storing expression permanently comprising:
receiving an expression object associated with a creator, the expression object comprising a creator-defined data expression; and
storing the expression object in a data storage system using a permanent expression object identifier associated with the creator to enable the creator to have permanent access to the expression object using the permanent expression object identifier.

21. The method of claim 20 wherein the expression object is permanently available to the creator from any device enabled for communication with the data storage system.

22. The method of claim 20 further comprising the act of receiving a single input indicating an intention by the creator to permanently store one or more portions of the data expression.

23. The method of claim 20 further comprising the act of receiving an input from a device authorized by the creator to download all or a portion of all expression objects associated with the creator.

24. The method of claim 23 further comprising the act of transmitting all selected expression objects associated with the creator to the authorized device.

25. The method of claim 24 wherein the expression objects have associated relationships and the act of transmitting includes transmitting associated relationship.

26. The method of claim 20 wherein the creator shares expression objects with another person by providing authorization to a device associated with the other person to access the expression objects associated with the creator.

27. The method of claim 26 further comprising receiving a destination device for a person other than the creator, the destination device being approved by the creator to access the expression objects; and
receiving a single input to transmit all selected matching expression objects associated with the creator to the destination device; and
transmitting all selected matching expression objects associated with the creator to the destination device, along with the creator-defined tags and the creator-defined organizational tagging.

28. A method of organizing data expression comprising:
receiving an expression object, the expression object comprising a data expression defined by the creator; and
receiving input from the creator to define one or more relationships relative to at least a first portion of a data expression object and a second portion of a data expression.

29. The method of claim 28 wherein the first and second portions are from a single data expression.

30. The method of claim 28 wherein the relationships are defined using categories for one or more portions of the data expression.

31. The method of claim 28 wherein the relationships are defined using tags associated with one or more portions of the data expression.

32. The method of claim 28 wherein the relationships are defined using links between one or more data expressions.

33. The method of claim 28 wherein the relationship is based on a creator-defined structure.

34. The method of claim 33 wherein the creator-defined structure comprises creator-defined categories, tags and/or links.
